(19) United States
(12) Patent Application Publication
(10) Pub. No.: US 2010/0088685 A1
(43) Pub. Date: Apr. 8, 2010

(54) SYSTEM AND METHOD FOR MAPPING A DOMAIN MODELING LANGUAGE TO A RELATIONAL STORE

(75) Inventors: Haroon Ahmed, Bellevue, WA (US); Anthony C. Bloesch, Vashon, WA (US); John David Doty, Seattle, WA (US); Martin James Gudgin, Sammamish, WA (US); John Braden Keiser, Renton, WA (US); David Evans Langworthy, Kirkland, WA (US); Clemens Alden Szyperski, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/415,949

(22) Filed: Mar. 31, 2009

Related U.S. Application Data
(60) Provisional application No. 61/103,135, filed on Oct. 6, 2008.

(51) Int. Cl. G06F 9/45; G06F 9/44

(52) U.S. Cl. 717/140; 717/117

(57) ABSTRACT

A method and system for mapping between constructs in a domain modeling language and a relational storage language is provided. A source code authored in a source language is received and a set of constructs in the source code are identified. The set of constructs in the source code are mapped to a set of constructs in a target language. The source code is then compiled into a target code authored in the target language such that one of the source code or target code include a declarative constraint-based and/or order-independent execution model.

### CROSS-REFERENCE TO RELATED APPLICATIONS

This application claims the benefit of U.S. Provisional Application Ser. No. 61/103,135, filed Oct. 6, 2008 entitled “SYSTEM AND METHOD FOR MAPPING A DOMAIN MODELING LANGUAGE TO A RELATIONAL STORE,” the entirety of which is incorporated herein by reference.

### TECHNICAL FIELD

The subject disclosure generally relates to mapping programming languages to a destination, and more particularly to mapping languages between a domain modeling system and a relational storage system.

### BACKGROUND

When a large amount of data is stored in a database, such as when a server computer collects large numbers of records, or transactions, of data over long periods of time, other computers sometimes desire access to that data or a targeted subset of that data. In such case, the other computers can query for the desired data via one or more query operators. In this regard, historically, relational databases have evolved for this purpose, and have been used for such large scale data collection, and various query languages have developed which instruct database management software to retrieve data from a relational database, or a set of distributed databases, on behalf of a querying client.

It is often desirable to author source code for such management functions in a declarative programming language. Unlike imperative programming languages, declarative programming languages allow users to write down what they want from their data without having to specify how those desires are met against a given technology or platform. However, current models authored in a declarative modeling language usually go through a series of tools that transform declarative definitions into various concrete implementation artifacts. Moreover, once a model is received by a database, the declarative nature of the model has been transformed into an imperative model, which may be undesirable. Accordingly, there is a need for a method and system for mapping between a domain modeling system and a relational storage system in which the declarative nature of an execution model is preserved.

The above-described deficiencies of current relational database systems and corresponding database management techniques are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Embodiments of a method and system for mapping between constructs in a domain modeling language and a relational storage language are described. In various non-limiting embodiments, the method includes receiving a source code authored in a source language and identifying a set of constructs in the source code. Within such embodiment, the set of constructs in the source code are mapped to a set of constructs in a target language. The source code is then compiled into a target code authored in the target language, such that one of the source code or the target code includes a declarative constraint-based execution model.

In another embodiment, a system is provided. Within such embodiment, a receiving component is configured to receive a source code authored in a source language. The system includes a first construct library configured to store constructs that support the domain modeling language, and a second construct library configured to store constructs that support the relational storage language. The system also includes a processor component configured to execute computer-readable instructions for mapping a set of constructs in the source code to a set of constructs in a target language. And finally, the system includes a compiling component configured to generate a target code authored in the target language and analogous to the source code, such that one of the source code or the target code includes a declarative order-independent execution model.

In yet another embodiment, a system for mapping between an M language programming code and an SQL programming code is provided. The system includes means for receiving a source code authored in either M or SQL, and means for identifying a set of constructs in the source code. The system also includes a means for mapping the set of constructs in the source code to a set of constructs in either M or SQL. A means for compiling the source code into a target code authored in either M or SQL is also provided, such that one of the source code or the target code includes a declarative constraint-based and order-independent execution model.

These and other embodiments are described in more detail below.

### BRIEF DESCRIPTION OF THE DRAWINGS

Various non-limiting embodiments are further described with reference to the accompanying drawings in which:

FIG. 1 is an illustration of a nominally typed execution system;

FIG. 2 is a non-limiting illustration of a type system associated with a constraint-based execution model according to an embodiment;

FIG. 3 is an illustration of data storage according to an ordered execution model;

FIG. 4 is a non-limiting illustration of data storage according to an order-independent execution model;

FIG. 5 is an exemplary process chain for multiple output types of a compiler according to an embodiment;

FIG. 6 is an exemplary block diagram of a domain modeling system interacting with a relational storage system according to an embodiment;

FIG. 7 is a block diagram illustrating an exemplary system for mapping a domain modeling language to a relational store according to an embodiment;

FIG. 8 is an illustration of an exemplary coupling of electrical components that effectuate mapping a domain modeling language to a relational store according to an embodiment;

FIG. 9 is an illustration of an exemplary mapping of a storage-identifying entity to a table according to an embodiment;

FIG. 10 is an illustration of an exemplary mapping of a storage-identifying entity referencing another storage-identifying entity as a table referencing another table according to an embodiment;

FIG. 11 is an illustration of an exemplary mapping of multiple storage-identifying entities referencing multiple storage-identifying entities as multiple columns in a table referencing multiple tables according to an embodiment;

FIG. 12 is an illustration of an exemplary mapping of an initialization according to an embodiment;

FIG. 13 is an illustration of an exemplary mapping of a nested initialization according to an embodiment;

FIG. 14 is an illustration of an exemplary mapping of a labeled initialization according to an embodiment;

FIG. 15 is a block diagram representing exemplary non-limiting networked environments in which various embodiments described herein can be implemented; and

FIG. 16 is a block diagram representing an exemplary non-limiting computing system or operating environment in which one or more aspects of various embodiments described herein can be implemented.

### DETAILED DESCRIPTION

As discussed in the background, among other things, conventional systems do not provide an adequate mechanism for translating declarative execution models into a relational storage language. Accordingly, in various non-limiting embodiments, the present invention provides a method and system for mapping constructs between a declarative domain modeling system and a relational storage system. It should be appreciated that an exemplary domain modeling programming language that is compatible with the scope and spirit of the disclosed subject matter is the M programming language (hereinafter “M”), which was developed by the assignee of the subject application. In one aspect, M is a purely declarative language that is operable to produce either an order-independent or constraint-based execution model. In addition to M, however, it is to be understood that other similar programming languages may be used, and that the utility of the disclosed subject matter is not limited to any single programming language.

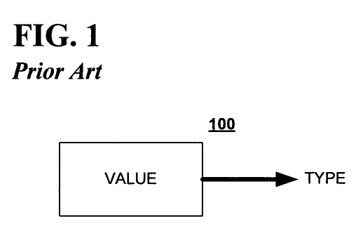

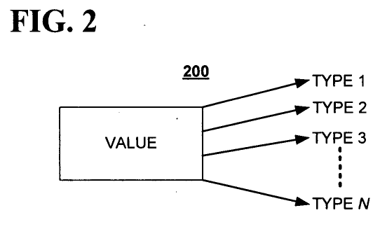

In one embodiment, the methods described herein are operable with a programming language, such as M, having a constraint-based type system. Such a constraint-based system provides functionality not simply available with traditional, nominal type systems. In FIGS. 1-2, a nominally typed execution system is compared to a constraint-based typed execution system according to an embodiment of the invention. As illustrated, the nominal system 100 assigns a particular type for every value, whereas values in constraint-based system 200 may conform with any of an infinite number of types.

For an illustration of the contrast between a nominally-typed execution model and a constraint-based typed model according to a declarative programming language described herein, such as the M programming language, exemplary code for type declarations of each model are compared below.

First, with respect to a nominally-typed execution model the following exemplary C# code is illustrative:

```
class A
{
    public string Bar;
    public int Foo;
}
class B
{
    public string Bar;
    public int Foo;
}
```

For this declaration, a rigid type-value relationship exists in which A and B values are considered incomparable even if the values of their fields, Bar and Foo, are identical.

In contrast, with respect to a constraint-based model, the following exemplary M code (discussed in more detail below) is illustrative of how objects can conform to a number of types:

type A { Bar : Text; Foo : Integer; }
type B { Bar : Text; Foo : Integer; }

For this declaration, the type-value relationship is much more flexible as all values that conform to type A also conform to B, and vice-versa. Moreover, types in a constraint-based model may be layered on top of each other, which provides flexibility that can be useful, e.g., for programming across various RDBMSs. Indeed, because types in a constraint-based model initially include all values in the universe, a particular value is conformable with all types in which the value does not violate a constraint codified in the type's declaration. The set of values conformable with type defined by the declaration type T:Text where value<128 thus includes “all values in the universe” that do not violate the “Integer” constraint or the “value<128” constraint.

Thus, in one embodiment, the programming language of the source code is a purely declarative language that includes a constraint-based type system as described above, such as implemented in the M programming language.

In an embodiment, the synchronization method described herein may also be operable with a programming language having an order-independent execution model. Similar to the aforementioned constraint-based execution model, such an order-independent execution model provides flexibility that is also particularly useful for programming across various RDBMSs.

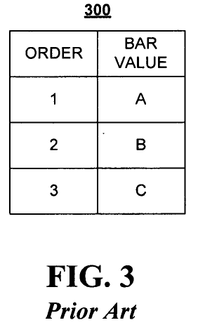

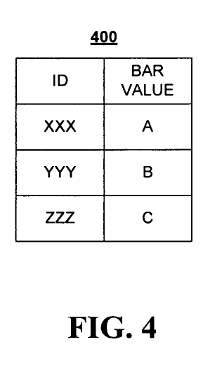

In FIGS. 3-4, a data storage abstraction according to an ordered execution model is compared to a data storage abstraction according to an order-independent execution model consistent with an embodiment of the invention. For this particular example, data storage abstraction 300 represents a list Foo created by an ordered execution model, whereas data abstraction 400 represents a similar list Foo created by an order-independent execution model according to an embodiment of the invention. As illustrated, each of data storage abstractions 300 and 400 include a set of three Bar values (i.e., “1”, “2”, and “3”). However, data storage abstraction 300 requires these Bar values to be entered/listed in a particular order, whereas data storage abstraction 400 has no such requirement. Instead, data storage abstraction 400 simply assigns an ID to each Bar value, wherein the order that these Bar values were entered/listed is unobservable to the targeted repository. Data storage abstraction 400 may have thus resulted from the following order-independent code:

f: Foo* = {Bar = “1”};
f: Foo* = {Bar = “2”};
f: Foo* = {Bar = “3”};

However, data storage abstraction 400 may have also resulted from the following code:

f: Foo* = {Bar = “3”};
f: Foo* = {Bar = “1”};
f: Foo* = {Bar = “2”};

And each of the two codes above may be functionally equivalent to the following code:

f: Foo*={{Bar=“2”}, {Bar=“3”}, {Bar=“1”}};

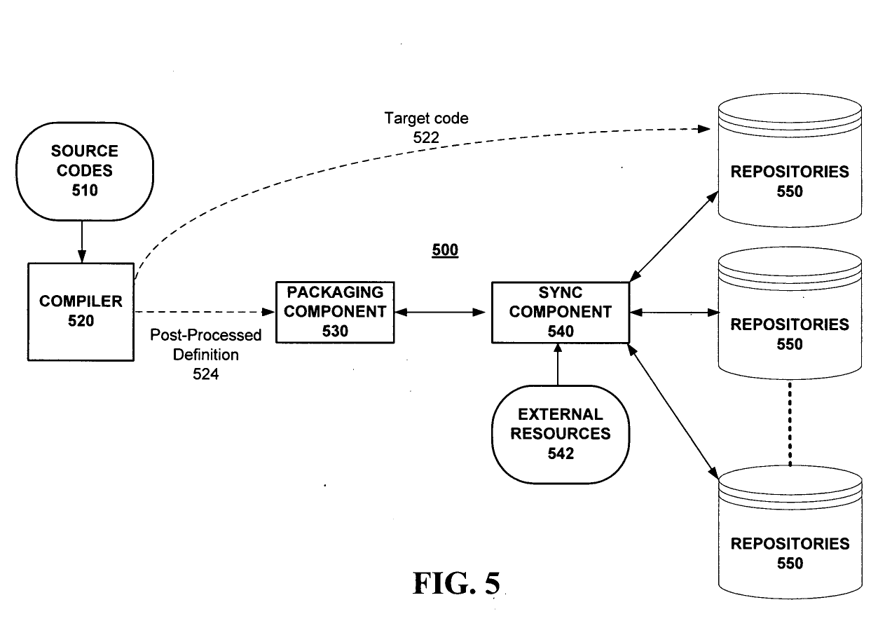

In an embodiment, it should be appreciated that aspects disclosed herein may be implemented as part of a compiling unit that is configured to compile source code in any of a plurality of ways. For instance, in FIG. 5, an exemplary system 500 is provided in which compiler 520 is configured to process source code 510 as either an intermediate post-processed definition of the source code 524 and/or a mapped compilation of the source code into a target code 522 compatible with repository 550 (e.g., Transact-SQL). Below, a brief overview describing embodiments that utilize the intermediate post-processed definitions 524 are first included, followed by a more detailed description of the direct mapping embodiments.

In an aspect, the post-processed definitions 524 include the processed source code and any of a plurality of designtime/runtime artifacts associated with the processed source code. Such artifacts, for example, may include artifacts based on dependencies to subsequent source models 510, other repositories 550, and/or external resources 542 (e.g., CLR assemblies). A packaging component 530 may then package the post-processed definitions 524 as image files, which are installable into particular repositories 550. Within such embodiment, image files include definitions of necessary metadata and extensible storage to store multiple transformed artifacts together with their declarative source model. For example, packaging component 530 may set particular metadata properties and store the declarative source definition together with compiler output artifacts as content parts in an image file.

As illustrated, system 500 may also include synchronization component 540, which may be utilized to manage image files. For example, synchronization component 540 may take an image file as an input and link it with a set of referenced image files. In between or afterwards, there could be several supporting tools (like re-writers, optimizers etc.) operating over the image files by extracting packaged artifacts, processing them and adding more artifacts in the same image file. These tools may also manipulate metadata of the image file to change the state of the image file (e.g., digitally signing an image file to ensure its integrity and security).

Next, a deployment utility deploys the image file and an installation tool installs it into a running execution environment within repositories 550. In an embodiment, repositories 550 are a collection of running relational database management systems (RDBMS). Here, however, it should be noted that the default system catalog of many RDBMSs do not provide adequate assistance to manage deployment of image files themselves or their packaged contents. In order to address this limitation, an embodiment may include having data structures included within an image file extracted and used to populate an extended catalog so as to augment the default system catalog of such RDBMSs.

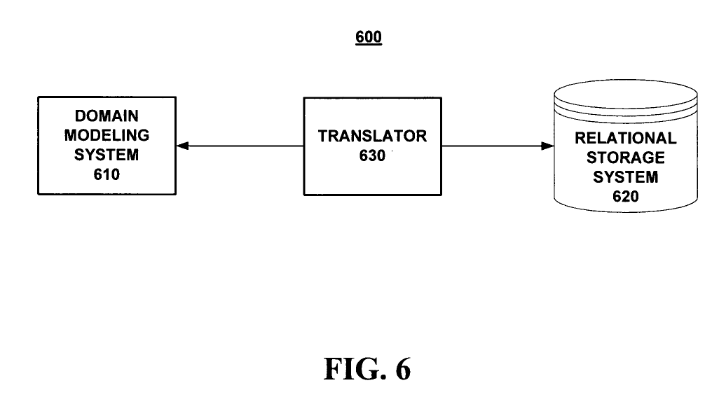

For some applications, however, it may be desirable for compiler 520 to directly provide target code 522. Accordingly, as illustrated in FIG. 6, an exemplary system 600 may facilitate having a domain modeling system 610 interacting directly with a relational storage system via a compiler/translator 630. Within such embodiment, source code in a language corresponding to domain modeling system 610 is compiled/translated by compiler/translator 630 into a language operable with storage system 620 (e.g., Transact-SQL). In another embodiment, source code in a language corresponding to relational storage system 620 is compiled/translated by compiler/translator 630 into a language operable with domain modeling system 610 (e.g., M).

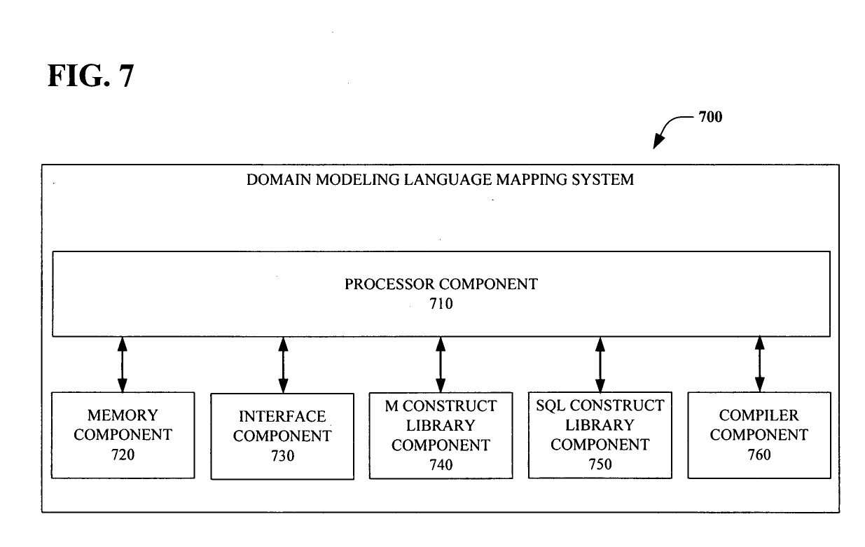

Referring next to FIG. 7, a block diagram illustrating components of an exemplary domain modeling language mapping system 700 is provided. As shown, such a system 700 may include a processor 710 coupled to each of a memory component 720, interface component 730, M construct library component 740, SQL construct library component 750, and compiler component 760.

In one aspect, processor component 710 is configured to execute computer-readable instructions related to performing any of a plurality of functions. Such functions may include controlling any of memory component 720, interface component 730, M construct library component 740, SQL construct library component 750, and/or compiler component 760. Other functions performed by processor component 710 may include analyzing information and/or generating information that can be utilized by any of memory component 720, interface component 730, M construct library component 740, SQL construct library component 750, and/or compiler component 760. Here, it should also be noted that processor component 710 can be a single processor or a plurality of processors.

In another aspect, memory component 720 is coupled to processor component 710 and configured to store computer-readable instructions executed by processor component 710. Memory component 720 may also be configured to store any of a plurality of other types of data including, for instance, queued source codes to be processed, syntactical rules, compile-time artifacts, etc., as well as data generated by any of interface component 730, M construct library component 740, SQL construct library component 750, and/or compiler component 760. Memory component 720 can be configured in a number of different configurations, including as random access memory, battery-backed memory, hard disk, magnetic tape, etc. Various features can also be implemented upon memory component 720, such as compression and automatic back up (e.g., use of a Redundant Array of Independent Drives configuration).

As shown, mapping system 700 may also include interface component 730. In an embodiment, interface component 730 is coupled to processor component 710 and configured to interface mapping system 700 with external entities. For instance, interface component 730 may be configured to receive source code from either a domain modeling language system and/or a relational store. Interface component 730 may also be configured to display an output to a user, as well as to transmit the output to an external entity (e.g., via a network connection).

In another aspect, mapping system 700 also includes M construct library 740 and SQL construct library 750, as shown. Within such embodiment, M construct library 740 and SQL construct library 750 respectively include a plurality of constructs in M and SQL that may be utilized to translate M code into SQL code, and vice-versa. Moreover, each of M construct library 740 and SQL construct library 750 provide the universe of constructs from which mapping system 700 may select to map a source code to a target code. Here, it should be appreciated that each individual construct in M does not necessarily have a particular corresponding construct in SQL. Nevertheless, as will be discussed in more detail below, by combining various constructs, an extensive mapping landscape may be provided.

Mapping system 700 also includes compiler component 760, as shown. In an embodiment, compiler component 760 is coupled to processor component 710 and configured to compile source code received via interface component 730. Here, it should be noted that compiler 760 may be configured to compile any of a plurality of types of compile-time artifacts. For instance, in an aspect, a plurality of candidate mappings for a given expression might be compiled, wherein particular rules may be utilized to subsequently select which candidate mapping to include at runtime.

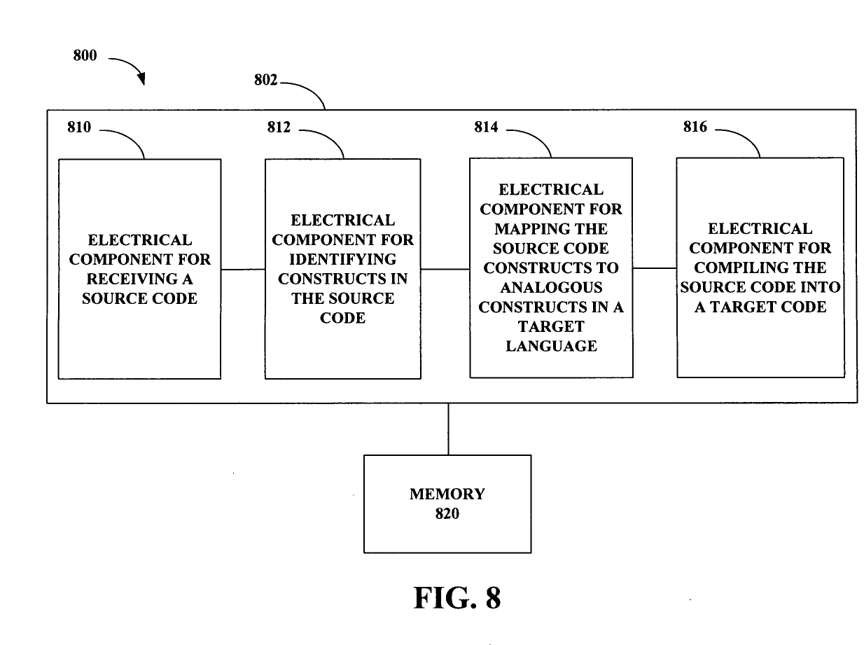

Referring next to FIG. 8, illustrated is a system 800 that enables mapping a domain modeling language to a relational store, in accordance with aspects disclosed herein. System 800 can reside within a computer, for instance. As depicted, system 800 includes functional blocks that can represent functions implemented by a processor, software, or combination thereof (e.g., firmware). System 800 includes a logical grouping 802 of electrical components that can act in conjunction. As illustrated, logical grouping 802 can include an electrical component for receiving a source code 810. Further, logical grouping 802 can include an electrical component for identifying particular constructs in the source code 812, and another electrical component for mapping the source code constructs to analogous constructs in a target language 814. And finally, logical grouping 802 can also include an electrical component for compiling the source code into a target code 816. Additionally, system 800 can include a memory 820 that retains instructions for executing functions associated with electrical components 810, 812, 814, and 816. While shown as being external to memory 820, it is to be understood that electrical components 810, 812, 814, and 816 can exist within memory 820.

### Exemplary Translations of Generic Programming Languages

In the discussion that follows, an overview of exemplary mappings are discussed within the context of a generic domain modeling language mapping to a generic relational storage language.

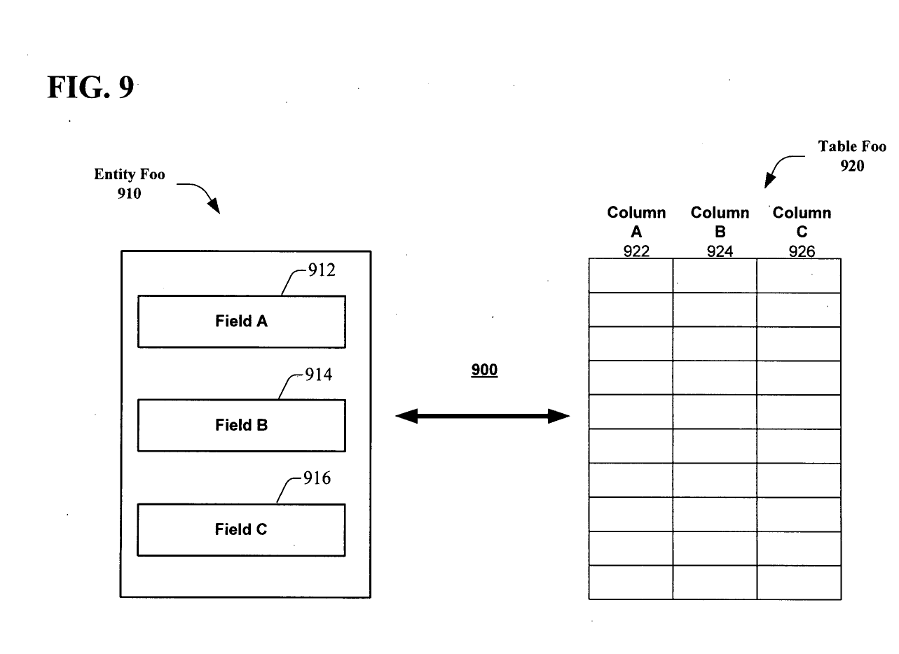

In an embodiment, any storage specifier in a domain modeling language may map to a corresponding table in the relational storage language. Within such embodiment, the domain modeling language includes a constraint-based system which maps to particular constraints imposed on tables in the relational storage language. In an aspect, whereas scalars may map to simple cells, entities having multiple identity fields may map to a table having multiple columns. An exemplary mapping of such a multi-field entity is provided in FIG. 9.

As illustrated, mapping 900 includes an Entity Foo 910 in a domain modeling language being mapped as a Table Foo 920 in a relational storage language. Within such embodiment, Entity Foo 910 includes Field A 912, Field B 914, and Field C 916, as shown. Here, it should be appreciated that each of Field A 912, Field B 914, and Field C 916 are themselves storage identifiers, which could be mapped to individual tables. Accordingly, each of Field A 912, Field B 914, and Field C 916 may correspond to a particular type of data (e.g., integer32, text, etc.), wherein particular constraints may be imposed on such data. In an embodiment, these data types and constraints are subsequently mapped to Column A 922, Column B 924, and Column C 926 such that Entity Foo 910 is analogous to Table Foo 920.

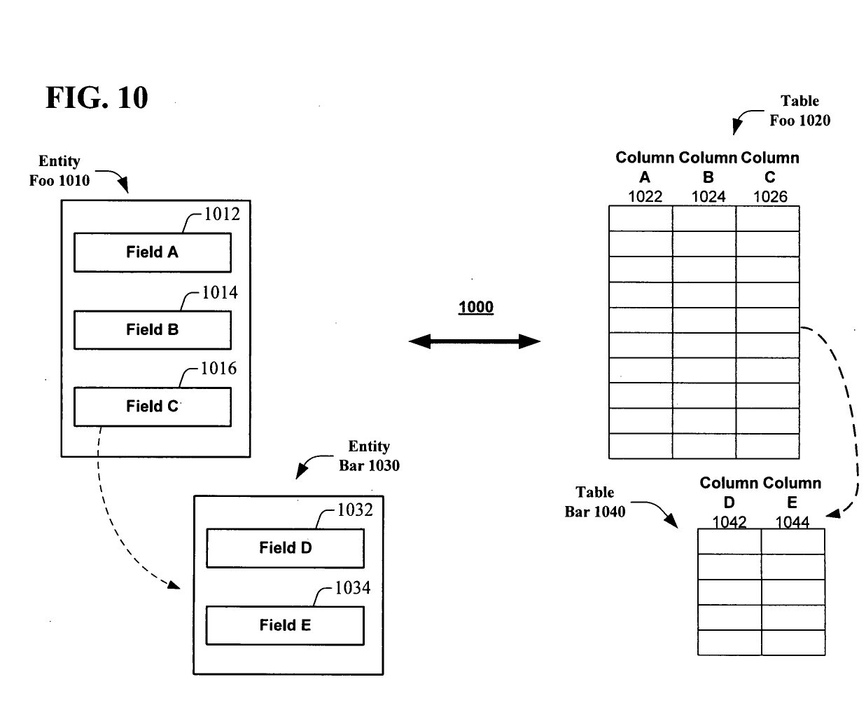

For some embodiments, it may be desirable for entities to reference other entities. Referring next to FIG. 10, an exemplary mapping of one entity referencing another reference is provided. As illustrated, mapping 1000 again includes Entity Foo 1010 being mapped to Table Foo 1020. Here, however, Field C 1016 makes an external reference to Entity Bar 1030, which maps to Column C 1026 making an external reference to Table Bar 1040.

In an aspect, it should be appreciated that mapping 1000 may similarly illustrate either a “one-to-many” or “one-to-one” entity reference. To implement the one-to-many pattern (e.g., Field C 1016 referencing Field D 1032 and Field E 1034, which maps to Column C 1026 referencing Column D 1042 and Column E 1044), an entity reference to the Parent in the child field may be included. Similarly, to implement a one-to-one pattern (e.g., Field C 1016 referencing Field E 1034 which maps to Column C 1026 referencing Column E 1044), an entity reference from one of the fields to the other may be included. Although, both relationships may look the same in the domain modeling language, the one-to-one relationship may be enforced in the relational storage language by utilizing a unique constraint.

In an embodiment, a mapping system implements entity references with a column with the same type as the entity's identity column, and a foreign key from the referencing table to the referenced table. Here, it should also be noted that retrieving particular values from either of Entity Foo 1010 or Entity Bar 1030 may be mapped as executing a “select” command on particular cells from either of Table Foo 1020 or Table Bar 1040, wherein multiple retrievals may be mapped as performing a “union” of multiple “select” commands. A more detailed discussion of such retrievals is provided later within the context of “member access” and “anonymous collections” in M.

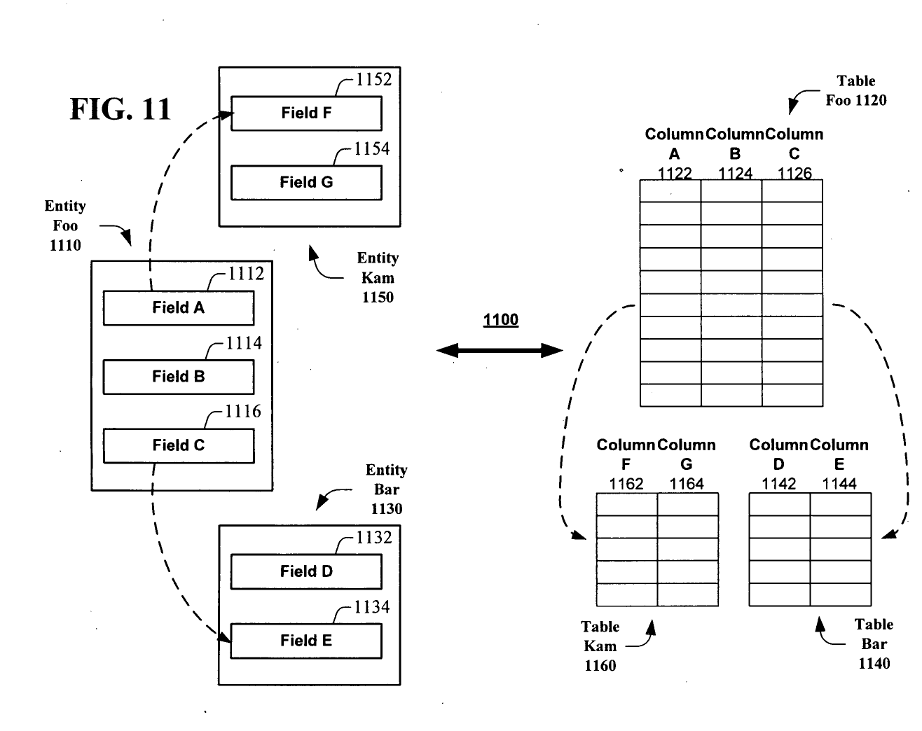

Referring next to FIG. 11, an exemplary mapping of a many-to-many entity reference pattern is provided. As illustrated, mapping 1100 includes Entity Foo 1110 referencing each of Entity Bar 1130 and Entity Kam 1150. In particular, such embodiment may include Field A 1112 referencing Field F 1152 and Field C 1116 referencing Field E 1134. In mapping such a referencing scheme, a combination of foreign key constructs may again be utilized so that Table Foo 1120 may reference each of Table Bar 1140 and Table Kam 1160. For instance, as illustrated, such mapping may include Column A 1122 referencing Column F 1162 and Column C 1126 referencing Column E 1144.

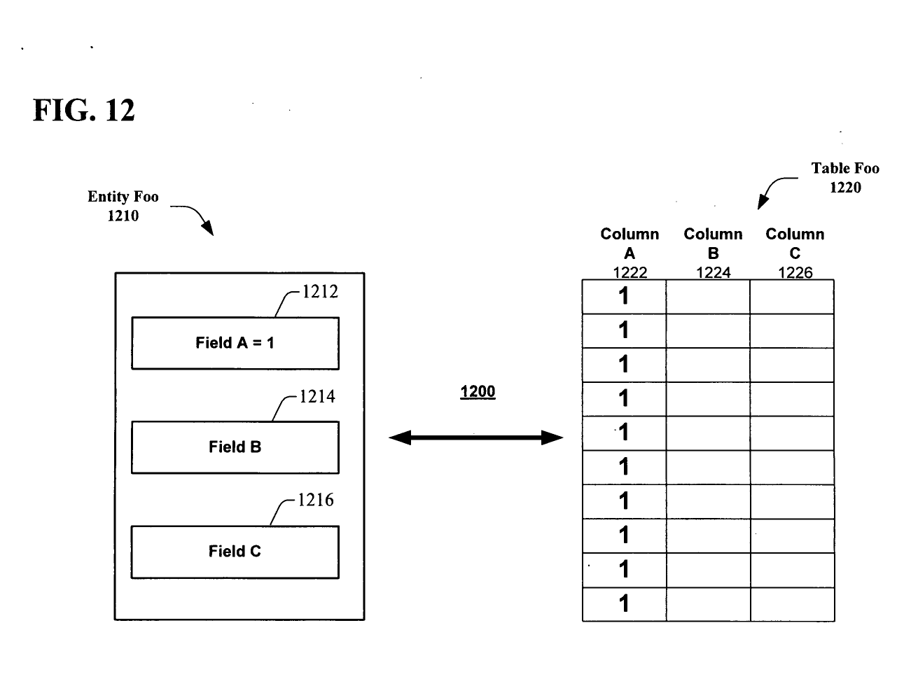

It should be further noted that various novel mapping schemes for performing initializations are also provided. To facilitate such initialization embodiments, an “insert” construct may be available in the relational storage language construct library. In FIG. 12, an exemplary mapping 1200 of how a simple initialization may be mapped is provided. In particular, an initialization of values in Field A 1212 to equal “1” is mapped as cells in Column A 1222 initialized to hold values of “1.”

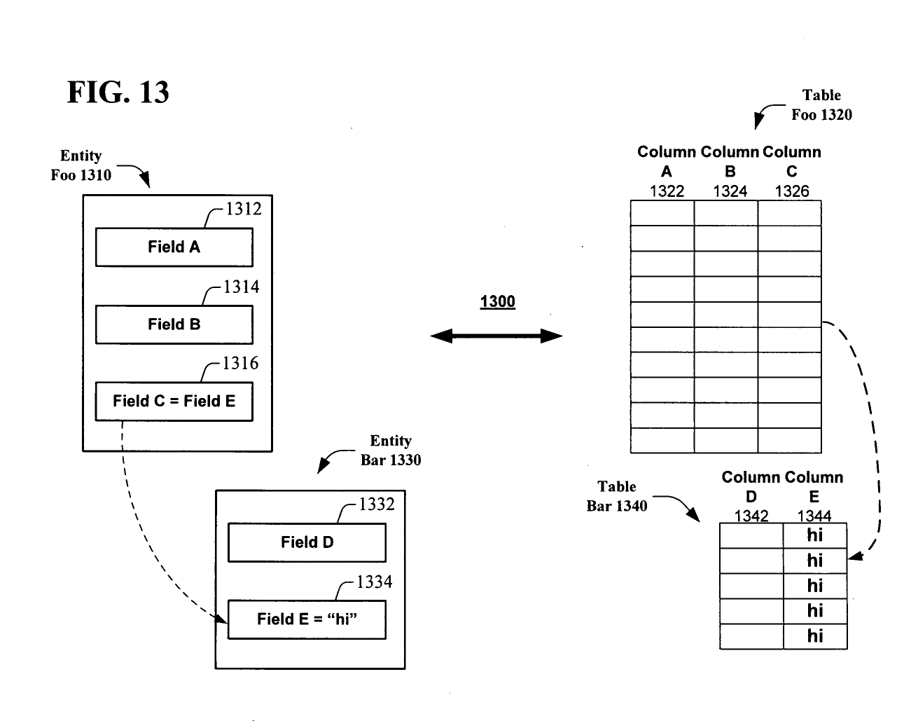

In some embodiments, mapping nested initialization schemes may also be supported. Indeed, as illustrated in FIG. 13, it may sometimes be desirable for a field in a first entity to be initialized by referencing a field in a second entity. For this particular embodiment, Field C 1316 in Entity Foo 1310 is shown as being initialized via reference to Field E 1334 in Entity Bar 1330. In mapping such a nested initialization, a foreign key may be utilized so that Column C 1326 in Table Foo 1320 may reference Column E 1344 in Table Bar 1340, as shown.

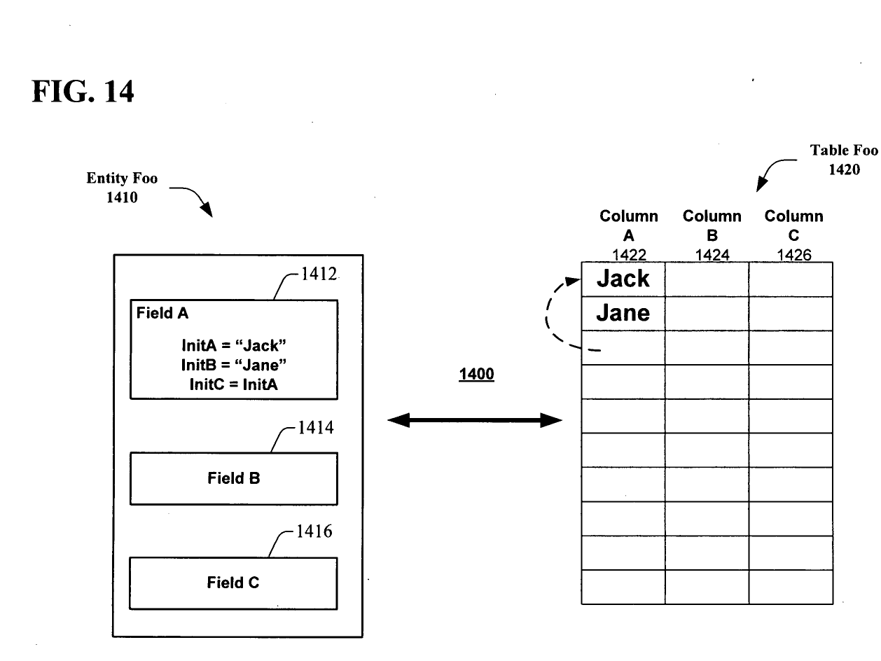

In yet another embodiment, labeled initialization schemes may also be supported, as illustrated in FIG. 14. Within such embodiment, labels may be included for each of a plurality of initialization expressions. Here, Field A 1412 includes three initialization expressions respectively labeled as InitA, InitB, and InitC. As illustrated, whereas, InitA and Init B respectively correspond to an independent initialization value, InitC references Init A and thus depends on the initialization value corresponding to the label “InitA.” When mapped to a relational storage language, a foreign key may be utilized to reference a particular cell in Table Foo 1420. Moreover, the labeling in Field A 1412 may be mapped as inserting a value into a cell in Table Foo 1420 and then declaring a location identifier to identify the cell for later referencing. Once the location of the cell has been declared, a subsequent initialization may then be performed by coupling the declared location with an “insert” command.

### Exemplary “M” to “SQL” Translations

As stated previously, an exemplary domain modeling programming language that is compatible with the scope and spirit of the disclosed subject matter is the M programming language. In the subsequent discussion, so as to provide additional context for some of the novel features described herein, a plurality of exemplary translations between M and SQL are discussed.

In an embodiment, with respect to basic types, scalar “M” types translate to scalar SQL types with the following mapping. “Constraint” is used when the SQL type does not perfectly represent the “M” type—for example, when it allows a larger range of values than the corresponding “M” type. In these cases, a CHECK constraint may be emitted on the table restricting the range of the value, as shown in Table T-1 below.

TABLE T-1

| “M” Type | SQL Type | Constraint |
|---|---|---|
| Integer8 | smallint | −128 . . . 127 |
| Integer16 | smallint | |
| Integer32 | Int | |
| Integer64 | bigint | |
| Unsigned8 | tinyint | |
| Unsigned16 | Int | 0 . . . 65535 |
| Unsigned32 | bigint | 0 . . . 4294967295 |
| Decimal9 | decimal(9, 6) | |
| Decimal19 | decimal(19, 6) | |
| Decimal28 | decimal(28, 6) | |
| Decimal38 | decimal(38, 6) | |
| Single | float(24) | |
| Double | float(53) | |
| DateTime | datetime | |
| Date | date | |
| Time | time | |
| Logical | Bit | |
| Character | nchar(1) | |
| Text | nvarchar(max) | |
| Text#n | nvarchar(n) | |
| Text where | nvarchar(n) | |
| value.Count <= n | | |
| Byte | tinyint | |
| Binary | varbinary(max) | |
| Guid | uniqueidentifier | |
| General | sql_variant | |

In an embodiment, no other scalar types are supported. The unsupported scalar types are: Scientific, Unsigned, Integer, Decimal, Number, and Unsigned64.

With respect to modules, “M”->SQL translates “M” “modules” to SQL “schemas.” Dots in module names may be translated directly to schema names. In an embodiment, all tables, functions and views generated from extents and computed values defined in a module are placed within that schema. In one aspect, module imports and exports are purely “M” constructs and have no effect on the SQL output by “M”->SQL. Exemplary translations for a module and dotted module are provided in Table T-2.

TABLE T-2

| | M Example | SQL Example |
|---|---|---|
| Module | module M { | create schema [M]; |
| | MyInt : Integer32; | create table [M].[MyInt] |
| | } | ( |
| | | [Item] int not null |
| | | ); |
| Dotted | module M.N { | create schema [M.N]; |
| Module | MyInt : Integer32; | create table [M.N].[MyInt] |
| | } | ( |
| | | [Item] int not null |
| | | ); |

In an embodiment, “M” extents are simply storage specifiers (e.g., “MyInts Integer32*” means “MyInts is a place where I can hold a bunch of integers.”). Within such embodiment, “M”->SQL compilation may translate extents into tables with the same name. Moreover, within such embodiment, all supported extents are converted to SQL tables.

In one aspect, “M”->SQL supports extents of four different variations: Scalar, collection of Scalar, Entity, and collection of Entity. With respect to entities, it should be appreciated that SQL tables may have columns of the same name as the entity fields. Exemplary translations for entities are provided in Table T-3.

TABLE T-3

| Type | M Example | SQL Example |
|---|---|---|
| Entity* | module M { | create table [M].[Foos] ( |
| | type Foo { | [i] int not null, |
| | i : Integer32; | [j] nvarchar(max) not null |
| | j : Text; | ); |
| | } | |
| | Foos : Foo*; | |
| | } | |
| Entity | module M { | create table [M].[AFoo] ( |
| | type Foo { | [i] int not null, |
| | i : Integer32; | [j] nvarchar(max) not null |
| | j : Text; | ); |
| | } | |
| | AFoo : Foo; | |
| | } | |

The translation of “M” scalar types to SQL scalar types has been discussed previously with respect to translating Basic Types. Nevertheless, it should be appreciated that SQL tables for scalars may have one column named “Item”, as described in Table T-4 below.

TABLE T-4

| Type | M Example | SQL Example |
|---|---|---|
| Scalar | module M { | create table [M].[AnInt] |
| | AnInt : Integer32; | ( |
| | } | [Item] int not null |
| | | ); |
| Scalar* | module M { | create table |
| | CollectionOfStrings : | [M].[CollectionOfStrings] |
| | Text*; | ( |
| | } | [Item] nvarchar(max) not null |
| | | ); |

As can be seen from the “Scalar” and “Entity” examples above, tables created to hold exactly one value may look the same as tables that hold many values. In some embodiments, “M” may be configured to assume there is always exactly one row in such tables. Enforcement of such assumption may then be achieved by creating appropriate constraints. In other embodiments, it should be appreciated that “M”->SQL may be configured to support collections of collections (such as GroupsOfPeople:(Person*)*).

With respect to identity columns, “M” entities may have one or more identity fields specified that make up a unique key for the entity. In one aspect, such identity is the basis for entity relationships (e.g., one-to-one, one-to-many and many-to-many relationships). “M”->SQL may support single or multiple field identities, and will create a primary key containing those columns. In some embodiments, “M”->SQL supports any type for identity, whereas other embodiments may exclude unconstrained Text. “M”->SQL may also support the identity autonumbering scheme of SQL.

In one aspect, “M”->SQL explicitly specifies the “clustered” keyword for the primary key even though it is the default for SQL. Within such embodiment, the clustered index is the index in which the data for the table is actually stored (so that it could be looked up quickly when the primary key is used to look it up). Exemplary translations for identities are provided in Table T-5.

TABLE T-5

| | M Example | SQL Example |
|---|---|---|
| Simple Identity | module M { | create table [M].[People] |
| | type Person { | ( |
| | PersonId : Integer32; | [PersonId] int not null, |
| | Name : Text; | [Name] nvarchar(max) not |
| | } where identity PersonId; | null, |
| | People : Person*; | constraint [PK_People] |
| | } | primary key clustered |
| | | ([PersonId]) |
| | | ); |
| Autonumbering | module M { | create table [M].[People] |
| Identity | type Person { | ( |
| | PersonId : Integer32 = | [PersonId] int not null |
| | AutoNumber( ); | identity, |
| | Name : Text; | [Name] nvarchar(max) not |
| | } where identity PersonId; | null, |
| | People : Person*; | constraint [PK_People] |
| | } | primary key clustered |
| | | ([PersonId]) |
| | | ); |
| Guid identity | module M { | create table [M].[People] |
| | type Person { | ( |
| | PersonId : Guid = | [PersonId] uniqueidentifier |
| | NewGuid( ); | not null default newid( ), |
| | Name : Text; | [Name] nvarchar(max) not |
| | } where identity PersonId; | null, |
| | People : Person*; | constraint [PK_People] |
| | } | primary key clustered |
| | | ([PersonId]) |
| | | ); |
| Multiple field | module M { | create table [M].[People] |
| identity | type Person { | ( |
| | FirstName : Text#100; | [FirstName] nvarchar(100) not |
| | LastName : Text#100; | null, |
| | } where | [LastName] nvarchar(100) not |
| | identity(FirstName,LastName); | null, |
| | People : Person*; | constraint [PK_People] |
| | } | primary key clustered |
| | | ([FirstName], [LastName]) |
| | | ); |

In some embodiments, unconstrained Text field identities are not supported because SQL cannot create a primary key for them. For such embodiments, in order to use a Text field as an identity, its length might be constrained. In other embodiments, it should also be noted that collection fields and nullable fields may be supported as part of a primary key. Furthermore, although primary keys that would take more than 900 bytes to store are presently unsupported due to limitations in SQL, future embodiments may include such primary keys.

Referring next to entity references, one-to-one and one-to-many relationships in “M” may be modeled using entity references. To implement the one-to-many pattern, an entity reference may be placed to the Parent in the child extent (e.g., OtherTable:OtherType). To implement one-to-one, an entity reference may be placed from one of the extents to the other (e.g., OtherTable:OtherType). It should be appreciated, however, that both of the above implementations look the same in “M”. (Note: to enforce the 1:1 relationship, a unique constraint can be used.)

In an embodiment, “M”->SQL implements entity references with a column with the same type as entity's identity column, and a foreign key from the referencing table to the referenced table. Meanwhile, trees are simply self-referencing one-to-many relationships. In one aspect, it should be noted that “M”->SQL will generate an error for entity references without a membership constraint (e.g., “where value in OtherExtent” or some variant thereof). Exemplary translations for entity references are provided in Table T-6.

TABLE T-6

| | M Example | SQL Example |
|---|---|---|
| One-to- | module M { | create table [M].[People] |
| many | type Person { | ( |
| | Id : Integer32 | [Id] int not null identity, |
| | = | [Name] nvarchar(max) not null, |
| | AutoNumber( ); | constraint [PK_People] primary key clustered |
| | Name : Text; | ([Id]) |
| | } where identity Id; | ); |
| | People : Person*; | go |
| | type TaxReturn { | create table [M].[TaxReturns] |
| | Id : Integer32; | ( |
| | Year : Integer16; | [Id] int not null, |
| | Citizen : Person | [Citizen] int not null, |
| | where value in People; | [Year] smallint not null, |
| | } where identity Id; | constraint [PK_TaxReturns] primary key |
| | TaxReturns : | clustered ([Id]), |
| | TaxReturn*; | constraint [FK_TaxReturns_Citizen_M_People] |
| | } | foreign key ([Citizen]) references |
| | | [M].[People] ([Id]) |
| | | ); |
| Tree | module M { | create table [M].[People] |
| | type Person { | ( |
| | PersonId : | [PersonId] int not null identity, |
| | Integer32 = AutoNumber( ); | [Mother] int null, |
| | Name : Text; | [Name] nvarchar(max) not null, |
| | Mother : Person? | constraint [PK_People] primary key clustered |
| | where value in People; | ([PersonId]), |
| | } where identity | constraint [FK_People_Mother_M_People] |
| | PersonId; | foreign key ([Mother]) references [M].[People] |
| | People : Person*; | ([PersonId]) |
| | } | ); |
| One-to- | module M { | create table [M].[People] |
| one | type Person { | ( |
| | PersonId : | [PersonId] int not null identity, |
| | Integer32 | [Name] nvarchar(max) not null, |
| | = | constraint [PK_People] primary key clustered |
| | AutoNumber( ); | ([PersonId]) |
| | Name : Text; | ); |
| | } where identity | create table [M].[CurrentSessions] |
| | PersonId; | ( |
| | People : Person*; | [Person] int not null, |
| | type CurrentSession { | [StartTime] time not null, |
| | Person : Person | constraint [Unique_CurrentSessions_Person] |
| | where value in People; | unique ([Person]), |
| | StartTime : Time; | constraint |
| | } where unique | [FK_CurrentSessions_Person_People] foreign key |
| | Person; | ([Person]) references [M].[People] |
| | CurrentSessions : | ([PersonId]) |
| | CurrentSession*; | ); |
| | } | |
| References | module M { | create table [M].[People] |
| to | type Person { | ( |
| entities | FirstName : | [FirstName] nvarchar(100) not null, |
| with | Text#100; | [LastName] nvarchar(100) not null, |
| multiple | LastName : | [Mother_FirstName] nvarchar(max) not null, |
| identity | Text#100; | [Mother_LastName] nvarchar(max) not null, |
| fields | Mother : Person | constraint [PK_People] primary key clustered |
| | where value in People; | ([FirstName], [LastName]), |
| | } where | constraint |
| | identity(FirstName, | [FK_People_Mother_FirstName_Mother_LastName_M_{—} |
| | LastName); | People] foreign key ([Mother_FirstName], |
| | People : Person*; | [Mother_LastName]) references [M].[People] |
| | } | ([FirstName], [LastName]) |
| | | ); |

“M”->SQL supports one-to-many (and one to one) relationships using collection fields. Unlike other entity fields, however, collection fields do not translate directly to a column in the underlying SQL table. Instead, a many-to-many “child table” is created with the name “<Extent>_<Field>”, with a parent id and an “Item” column to hold the values. If the parent has a multi-column primary key, the parent reference in the child table may be multi-column as well. For collections of entities, the “Item” column(s) of the child table may be a foreign key to the storage in the same manner as a one-to-many relationship. In one aspect, the child table has “on delete cascade” specified, so that if a row in the parent table is deleted, corresponding rows in the child table will also be deleted. In other aspects, collection fields are only supported if the containing entity has an identity field, so that the parent ID could be mapped to. Exemplary translations for many-to-many relationships are provided in Table T-7.

TABLE T-7

| | M Example | SQL Example |
|---|---|---|
| Many- | module M { | create table [M].[People] |
| to- | type Person | ( |
| many | { | [PersonId] int not null, |
| scalars | PersonId | [Name] nvarchar(max) not null, |
| | : Integer32; | constraint [PK_People] primary key clustered |
| | Name : | ([PersonId]) |
| | Text; | ); |
| | EmailAddresses : | create table [M].[People_EmailAddresses] |
| | Text*; | ( |
| | }; | [_Id] bigint not null identity, |
| | People : | [People_Id] int not null, |
| | Person*; | [Item] nvarchar(max) not null, |
| | } | constraint [PK_People_EmailAddresses] primary key |
| | | clustered ([_Id]), |
| | | constraint [FK_People_EmailAddresses_People_Id_People] |
| | | foreign key ([People_Id]) references [M].[People] |
| | | ([PersonId]) on delete cascade |
| | | ); |
| Many- | module M { | create table [M].[People] |
| to- | type Person | ( |
| many | { | [PersonId] int not null, |
| entities | PersonId | [Name] nvarchar(max) not null, |
| | : Integer32; | constraint [PK_People] primary key clustered |
| | Name : | ([PersonId]) |
| | Text; | ); |
| | Addresses : | create table [M].[Addresses] |
| | Address*; | ( |
| | } where | [AddressId] int not null, |
| | identity | [Street] nvarchar(max) not null, |
| | PersonId; | [ZipCode] int not null, |
| | People : | constraint [PK_Addresses] primary key clustered |
| | Person* where | ([AddressId]) |
| | item.Addresses | ); |
| | <= Addresses; | create table [M].[People_Addresses] |
| | type Address | ( |
| | { | [_Id] bigint not null identity, |
| | AddressId : | [People_Id] int not null, |
| | Integer32; | [Item] int not null, |
| | Street : | constraint [PK_People_Addresses] primary key clustered |
| | Text; | ([_Id]), |
| | ZipCode | constraint [FK_People_Addresses_People_Id_People] |
| | : Integer32; | foreign key ([People_Id]) references [M].[People] |
| | } where | ([PersonId]) on delete cascade, |
| | identity | constraint [FK_People_Addresses_Item_] foreign key |
| | AddressId; | ([Item]) references [M].[Addresses] ([AddressId]) |
| | Addresses : | ); |
| | Address*; | |
| | } | |
| Many- | module M { | create table [M].[People] |
| to- | type Person | ( |
| many | { | [FirstName] nvarchar(100) not null, |
| entities | FirstName : | [LastName] nvarchar(100) not null, |
| referring | Text#100; | constraint [PK_People] primary key clustered |
| to | LastName | ([FirstName], [LastName]) |
| table | : Text#100; | ); |
| with | Friends | create table [M].[People_Friends] |
| multiple | : People*; | ( |
| identity | } where | [_Id] bigint not null identity, |
| fields | identity(FirstName, | [People_FirstName] nvarchar(max) not null, |
| | LastName); | [People_LastName] nvarchar(max) not null, |
| | People : | [Item_FirstName] nvarchar(max) not null, |
| | Person*; | [Item_LastName] nvarchar(max) not null, |
| | } | constraint [PK_People_Friends] primary key clustered |
| | | ([_Id]), |
| | | constraint |
| | | [FK_People_Friends_People_FirstName_People_LastName_M_People |
| | | ] foreign key ([People_FirstName], [People_LastName]) |
| | | references [M].[People] ([FirstName], [LastName]) on |
| | | delete cascade, |
| | | constraint |
| | | [FK_People_Friends_Item_FirstName_Item_LastName_M_People] |
| | | foreign key ([Item_FirstName], [Item_LastName]) |
| | | references [M].[People] ([FirstName], [LastName]) |
| | | ); |
| Many- | module M { | create table [M].[People] |
| to- | type Person | ( |
| many | { | [PersonId] int not null, |
| scalars | FirstName : | [Name] nvarchar(max) not null, |
| where | Text#100; | constraint [PK_People] primary key clustered |
| parent | LastName | ([PersonId]) |
| table | : Text#100; | ); |
| has | EmailAddresses : | create table [M].[People_EmailAddresses] |
| multiple | Text*; | ( |
| identity | } where | [_Id] bigint not null identity, |
| fields | identity(FirstName, | [People_FirstName] nvarchar(max) not null, |
| | LastName); | [People_LastName] nvarchar(max) not null, |
| | People : | [Item] nvarchar(max) not null, |
| | Person*; | constraint [PK_People_EmailAddresses] primary key |
| | } | clustered ([_Id]), |
| | | constraint |
| | | [FK_People_EmailAddresses_People_FirstName_People_LastName |
| | | _M_People] foreign key ([People_FirstName], |
| | | [People_LastName]) references [M].[People] ([FirstName], |
| | | [LastName]) on delete cascade |
| | | ); |

It should be appreciated that fields can have default values in “M”, for example “MyGuid:Guid=NewGuid( )” or “Z: Integer32=0.” “M”->SQL translates simple constant defaults into the “default” keyword for a column. Future embodiments may also include default values for more complex values including references to columns, subqueries, and math operators. As a result, an “insert into” command may be applied to a table without specifying those values, and they will be replaced with their defaults. Here, it should also be noted that an “AutoNumber( )” default, only specifiable on an integer identity field, may also be used which will cause the field type to be “identity.” In future embodiments, it should be further noted that “M”->SQL may handle default values for collection and/or entity columns, including default values that refer to collection or entity columns in the same extent. Exemplary translations for implementing default values are provided in Table T-8.

TABLE T-8

| | M Example | SQL Example |
|---|---|---|
| Simple Default | module M { | create table [M].[People] |
| | type Person { | ( |
| | PersonId : | [PersonId] int not null, |
| | Integer32; | [IsAlive] bit not null default 1, |
| | Name : Text; | [Name] nvarchar(max) not null, |
| | IsAlive : Logical | constraint [PK_People] primary key |
| | = true; | clustered ([PersonId]) |
| | } where identity | ); |
| | PersonId; | |
| | People : Person*; | |
| | } | |
| Autonumbering | module M { | create table [M].[People] |
| Identity | type Person { | ( |
| | PersonId : | [PersonId] int not null identity, |
| | Integer32 = AutoNumber( ); | [Name] nvarchar(max) not null, |
| | Name : Text; | constraint [PK_People] primary key |
| | } where identity | clustered ([PersonId]) |
| | PersonId; | ); |
| | People : Person*; | |
| | } | |

Referring next to constraints, in one embodiment, aside from membership and identity constraints, all “where” constraints on a type are translated in “M”->SQL as CHECK constraints. In order to allow a richer set of expressions, CHECK constraints may be placed in a function returning a Logical value. It should also be noted that, before CHECK constraints are created, identity and foreign key constraints may be removed from the expression (i.e. they will not be turned into CHECK constraints) by, for example, breaking up the expression by &&'s. So if the “M” has a constraint such as: “where identity(Id) && Address in Addresses && Age >10”, “Age >10” is turned into a check constraint, but the first two constraints will not because they are identity and foreign key constraints, respectively. Exemplary translations for implementing constraints are provided in Table T-9.

TABLE T-9

| | M Example | SQL Example |
|---|---|---|
| Column | module M { | create function [M].[People_check_1] |
| Constraint | type Person { | ( |
| | Gender : Text | @Gender as nvarchar(max) |
| | where value == “M” \|\| | ) |
| | value == “F”; | returns bit as |
| | }; | begin |
| | People : Person*; | return case |
| | } | when @Gender = N‘M’ or @Gender = N‘F’ |
| | | then 1 |
| | | else 0 |
| | | end |
| | | end |
| | | go |
| | | create table [M].[People] |
| | | ( |
| | | [Gender] nvarchar(max) not null, |
| | | check ([M].[People_check_1]([Gender]) |
| | | = 1) |
| | | ); |
| Extent | module M { | create function [M].[People_check_1] |
| Constraint | type Person { | ( |
| | Gender : Text; | @Gender as nvarchar(max) |
| | } where value.Gender | ) |
| | == “M” \|\| value.Gender == | returns bit as |
| | “F”; | begin |
| | People : Person*; | return case |
| | } | when @Gender = N‘M’ or @Gender = N‘F’ |
| | | then 1 |
| | | else 0 |
| | | end |
| | | end |
| | | go |
| | | create table [M].[People] |
| | | ( |
| | | [Gender] nvarchar(max) not null, |
| | | check ([M].[People_check_1]([Gender]) |
| | | = 1) |
| | | ); |
| Unique | module M { | create table [M].[People] |
| Constraint | type Person { | ( |
| | FirstName : | [FirstName] nvarchar(100) not null, |
| | Text#100; | [Gender] nvarchar(max) not null, |
| | LastName : | [LastName] nvarchar(100) not null, |
| | Text#100; | constraint |
| | Gender : Text; | [Unique_People_FirstName_LastName] |
| | } where unique | unique ([FirstName], [LastName]) |
| | (FirstName, LastName); | ); |
| | People : Person*; | |
| | } | |
| Identity | module M { | create table [M].[People] |
| constraint | type Person { | ( |
| | PersonId : | [PersonId] int not null identity, |
| | Integer32 | [Name] nvarchar(max) not null, |
| | = | constraint [PK_People] primary key |
| | AutoNumber( ); | clustered ([PersonId]) |
| | Name : Text; | ); |
| | } where identity | |
| | PersonId; | |
| | People : Person*; | |
| | } | |
| Foreign key | module M { | create table [M].[People] |
| constraint | type Person { | ( |
| | PersonId : | [PersonId] int not null identity, |
| | Integer32 | [Name] nvarchar(max) not null, |
| | = | constraint [PK_People] primary key |
| | AutoNumber( ); | clustered ([PersonId]) |
| | Name : Text; | ); |
| | } where identity | create table [M].[CurrentSessions] |
| | PersonId; | ( |
| | People : Person*; | [Person] int not null, |
| | type CurrentSession { | [StartTime] time not null, |
| | Person : Person | constraint |
| | where value in People; | [FK_CurrentSessions_Person_People] |
| | StartTime : Time; | foreign key ([Person]) references |
| | }; | [M].[People] ([PersonId]) |
| | CurrentSessions : | ); |
| | CurrentSession*; | |
| | } | |

In some embodiments, translations of computed values inside an extent may also be contemplated. Here, it should be noted that such computed values translate into computed columns in SQL-speak.

Extents may also be initialized. In an embodiment, “M” extents can have one or more initializers that state the data that needs to be in the table. Within such embodiment, “M”->SQL translates these initializers into insert statements. Nested entity and collection initializers may also be supported. In one aspect, when values that have defaults are not filled in, the corresponding SQL INSERT is not filled in either, and SQL fills in the values itself. Exemplary translations for implementing an initialization are provided in Table T-10.

TABLE T-10

| | M Example | SQL Example |
|---|---|---|
| Scalar | module M { | create table [M].[SingleInt] |
| | SingleInt : Integer32 | ( |
| | = 10; | [Item] int not null |
| | } | ); |
| | | insert into [M].[SingleInt] ([Item]) |
| | | values (10); |
| Scalar | module M { | create table [M].[Ints] |
| Collection | Ints : Integer32* = { | ( |
| | 10, 20 }; | [Item] int not null |
| | } | ); |
| | | insert into [M].[Ints] ([Item]) |
| | | values (10); |
| | | insert into [M].[Ints] ([Item]) |
| | | values (20); |
| Entity | module M { | create table [M].[SingleFoo] |
| | type Foo { | ( |
| | i : Integer32; | [i] int not null, |
| | j : Text = | [j] nvarchar(max) not null default |
| | “initial value”; | N‘initial value’ |
| | }; | ); |
| | SingleFoo : Foo = { i | insert into [M].[SingleFoo] ([i]) |
| | = 10 }; | values (10); |
| | } | |
| Entity | module M { | create table [M].[Foos] |
| Collection | type Foo { | ( |
| | i : Integer32; | [i] int not null, |
| | j : Text = | [j] nvarchar(max) not null default |
| | “initial value”; | N‘initial value’ |
| | }; | ); |
| | Foos : Foo* = { | insert into [M].[Foos] ([i], [j]) |
| | { i = 10, j = “hi” | values (10, N‘hi’); |
| | }, | insert into [M].[Foos] ([i]) |
| | { i = 1 } | values (1); |
| | }; | |
| | } | |
| Nested | module M { | create table [M].[Bars] |
| Entity | type Bar { | ( |
| Reference | Id : Integer32 = | [Id] int not null identity, |
| | AutoNumber( ); | [x] int not null, |
| | x : Integer32; | [y] nvarchar(max) not null default |
| | y : Text = | N‘initial value’, |
| | “initial value”; | constraint [PK_Bars] primary key |
| | } where identity(Id); | clustered ([Id]) |
| | type Foo { | ); |
| | i : Integer32; | create table [M].[Foos] |
| | bar : Bar; | ( |
| | }; | [bar] int not null, |
| | Bars : Bar*; | [i] int not null, |
| | Foos : Foo* where | constraint [FK_Foos_bar_M_Bars] foreign |
| | item.bar in Bars = { | key ([bar]) references [M].[Bars] ([Id]) |
| | { i = 10, bar = { | ); |
| | x = 10 } }, | insert into [M].[Bars] ([x]) |
| | { i = 1, bar = { x | values (10); |
| | = 20, y = “hi” } } | declare @M_Bars_Id0 bigint = @@identity; |
| | }; | insert into [M].[Bars] ([x], [y]) |
| | } | values (20, N‘hi’); |
| | | declare @M_Bars_Id1 bigint = @@identity; |
| | | insert into [M].[Foos] ([i], [bar]) |
| | | values (10, @M_Bars_Id0); |
| | | insert into [M].[Foos] ([i], [bar]) |
| | | values (1, @M_Bars_Id1); |
| Nested | module M { | create table [M].[Bars] |
| Entity | type Bar { | ( |
| Collection | Id : Integer32 = | [Id] int not null identity, |
| Reference | AutoNumber( ); | [x] int not null, |
| | x : Integer32; | [y] nvarchar(max) not null default |
| | y : Text = | N‘initial value’, |
| | “initial value”; | constraint [PK_Bars] primary key |
| | } where identity(Id); | clustered ([Id]) |
| | type Foo { | ); |
| | Id : Integer32 = | create table [M].[Foos] |
| | AutoNumber( ); | ( |
| | i : Integer32; | [Id] int not null identity, |
| | bars : Bar*; | [i] int not null, |
| | } where identity(Id); | constraint [PK_Foos] primary key |
| | Bars : Bar*; | clustered ([Id]) |
| | Foos : Foo* where | ); |
| | item.bars <= Bars = { | create table [M].[Foos_bars] |
| | { i = 10, bars = { | ( |
| | { x = 10 }, { x = 100, y = | [_Id] bigint not null identity, |
| | “lo” } }}, | [Foos_Id] int not null, |
| | { i = 1, bars = { | [Item] int not null, |
| | { x = 20, y = “hi” } }} | constraint [PK_Foos_bars] primary key |
| | }; | clustered ([_Id]), |
| | } | constraint |
| | | [FK_Foos_bars_Foos_Id_M_Foos] foreign key |
| | | ([Foos_Id]) references [M].[Foos] ([Id]) |
| | | on delete cascade, |
| | | constraint [FK_Foos_bars_Item_M_Bars] |
| | | foreign key ([Item]) references |
| | | [M].[Bars] ([Id]) |
| | | ); |
| | | go |
| | | insert into [M].[Bars] ([x]) |
| | | values (10); |
| | | declare @M_Bars_Id0 bigint = @@identity; |
| | | insert into [M].[Bars] ([x], [y]) |
| | | values (100, N‘lo’); |
| | | declare @M_Bars_Id1 bigint = @@identity; |
| | | insert into [M].[Bars] ([x], [y]) |
| | | values (20, N‘hi’); |
| | | declare @M_Bars_Id2 bigint = @@identity; |
| | | insert into [M].[Foos] ([i]) |
| | | values (10); |
| | | declare @M_Foos_Id0 bigint = @@identity; |
| | | insert into [M].[Foos] ([i]) |
| | | values (1); |
| | | declare @M_Foos_Id1 bigint = @@identity; |
| | | insert into [M].[Foos_bars] ([Item], |
| | | [Foos_Id]) |
| | | values (@M_Bars_Id0, @M_Foos_Id0); |
| | | insert into [M].[Foos_bars] ([Item], |
| | | [Foos_Id]) |
| | | values (@M_Bars_Id1, @M_Foos_Id0); |
| | | insert into [M].[Foos_bars] ([Item], |
| | | [Foos_Id]) |
| | | values (@M_Bars_Id2, @M_Foos_Id1); |

In the above initializations, it should be noted that any depth of nested entity reference may be supported. It should be further noted that embodiments that include initialization of nested entities and entity references may also be contemplated when the referenced/nested entity is part of an extent with multi-field identity.

Referring next to labeled extent initialization, when inserting instances, the instances may be labeled and referred to in other insert statements or in expressions. Meanwhile, labeled scalars may be translated as constants wherever they are seen. Exemplary translations for labeled entities are provided in Table T-11.

TABLE T-11

| | M Example | SQL Example |
|---|---|---|
| Labeled | module M { | create table [M].[Ints] |
| Scalar | Ints : Integer32* = { A | ( |
| | { 10 }, B { 20 } }; | [Item] int not null |
| | MoreInts : Integer32* = | ); |
| | { Ints.B, Ints.A }; | create table [M].[MoreInts] |
| | F( ) { Ints.A + Ints.B } | ( |
| | } | [Item] int not null |
| | | ); |
| | | create function [M].[F] |
| | | ( |
| | | ) |
| | | returns int as |
| | | begin |
| | | return 10 + 20 |
| | | end |
| | | insert into [M].[Ints] ([Item]) |
| | | values (10) |
| | | ; |
| | | insert into [M].[Ints] ([Item]) |
| | | values (20) |
| | | ; |
| | | insert into [M].[MoreInts] ([Item]) |
| | | values (20) |
| | | ; |
| | | insert into [M].[MoreInts] ([Item]) |
| | | values (10); |
| Labeled | module M { | create table [M].[People] |
| Entity | type Person { | ( |
| | Id : Integer32 = | [Id] int not null identity, |
| | AutoNumber( ); | [Mother] int null, |
| | Name : Text; | [Name] nvarchar(max) not null, |
| | Mother : People?; | constraint [PK_People] primary key |
| | } where identity(Id); | clustered ([Id]), |
| | People : Person* = { | constraint [FK_People_Mother_M_People] |
| | Jack { Name = | foreign key ([Mother]) references |
| | “Jack”, Mother = Jane }, | [M].[People] ([Id]) |
| | Jane { Name = “Jane” | ); |
| | }, | insert into [M].[People] ([Name]) |
| | John { Name = | values (N‘Jane’); |
| | “John”, Mother = Jane }, | declare @M_People_Id1 bigint = |
| | Manfred { Name = | @@identity; |
| | “Manfred”, Mother = Martha | insert into [M].[People] ([Name], |
| | }, | [Mother]) |
| | Martha { Name = | values (N‘Jack’, @M_People_Id1); |
| | “Martha” }, | insert into [M].[People] ([Name], |
| | }; | [Mother]) |
| | } | values (N‘John’, @M_People_Id1); |
| | | insert into [M].[People] ([Name]) |
| | | values (N‘Martha’); |
| | | declare @M_People_Id4 bigint = |
| | | @@identity; |
| | | insert into [M].[People] ([Name], |
| | | [Mother]) |
| | | values (N‘Manfred’, @M_People_Id4); |

In the above translations, it should be noted that embodiments where references to labeled entities are supported may also be contemplated. Other embodiments that may be contemplated include references to labeled entities with multiple identity fields.

Referring next to identifiers and collisions, all views, functions, tables, columns, constraints, and triggers created in “M” may have names that are similar to the underlying table. However, because SQL only supports 128-character names, if the name of an identifier would be longer than 128 characters, it may be truncated to 128 characters.

In an embodiment, identifier collisions are also detected and disambiguated. It is possible for conflicts between autogenerated names to exist. For example in the following “M” code, it can create a conflict between the autogenerated join table and the declared “People_Addresses” extent:

```
module M {
    type Address {
        Id : Integer32;
        Street : Text;
        City : Text;
        State : Text;
    } where identity Id;
    type Person {
        Id : Integer32;
        Name : Text;
        Addresses : Address*;
    } where identity Id;
    People : Person* where item.Addresses <= Addresses;
    Addresses : Address*;
    People_Addresses : Integer32;
}
```

In an embodiment, when collisions are detected, a number is appended to the database object in question. In the example above, these two objects would be named “People_Addresses” and “People_Addresses1.” How these numbers are assigned may be contemplated in other embodiments.

Next module-level computed values are discussed. In an embodiment, computed values in “M” represent functions, expressions or queries that can be reused. Within such embodiment, computed values can have a range of expressions.

In one aspect, “M”->SQL translates computed values into scalar functions, table-valued functions, or views, depending on their most probable usage in SQL, which may be based on the return type and parameters to the function. Scalar functions may be created when the computed value return type is scalar, which allows these functions to be used like “SELECT*Module.Function(2)+1”. Meanwhile, views may be created when the computed value has no parameters and the return type is an entity or a collection, which allows views to be used like “SELECT*FROM Module.View”. Table-valued functions may then be created when the computed value has parameters and the return type is an entity or a collection, which allows these functions to be used like “SELECT*FROM Module.Function(10)”. It should be noted that, in addition to supporting scalars in parameters, future embodiments in which “M”->SQL supports entity and collection parameters to computed values may also be contemplated. Exemplary translations for module-level computed values are provided in Table T-12.

TABLE T-12

| | M Example | SQL Example |
|---|---|---|
| View | module M { | create view [M].[BigFoos] |
| | type Foo { i : Integer32; } | as |
| | Foos : Foo*; | select [t0].[i] |
| | BigFoos( ) : Foo* { Foos where | from ( select [i] as |
| | value.i > 100 } | [i] |
| | } | from [M].[Foos]) as |
| | | [t0] |
| | | where [t0].[i] > 100; |
| Scalar | module M { | create function |
| Function | MyInt : Integer32; | [M].[DoubleMyInt] |
| | DoubleMyInt( ) : Integer32 { MyInt * | ( |
| | 2 } | ) |
| | } | returns int as |
| | | begin |
| | | return (select [Item] |
| | | as [Item] |
| | | from [M].[MyInt]) * 2 |
| | | end |
| Scalar | module M { | create function |
| Function | Square(x : Integer32) : Integer32 { | [M].[Square] |
| | x * x } | ( |
| | } | @x as int |
| | | ) |
| | | returns int as |
| | | begin |
| | | return @x * @x |
| | | end |
| Table Valued | module M { | create function |
| Function | type Foo { i : Integer32; } | [M].[BigFoos] |
| | Foos : Foo*; | ( |
| | BigFoos(minValue : Integer32) : | @minValue as int |
| | Foo* { Foos where value.i > minValue } | ) |
| | } | returns table |
| | | as return ( |
| | | select [t0].[i] |
| | | from ( select [i] |
| | | as [i] |
| | | from [M].[Foos]) as |
| | | [t0] |
| | | where [t0].[i] > |
| | | @minValue |
| | | ) |

Query return types may also be supported. For table-valued functions and views, the returned rowset may have the same set of columns that the corresponding table would have. Therefore, in one aspect, any SQL query that can be done on a table of type T, can also be done with a view or function returning type T. The way various types may be represented in tables was discussed previously with respect to extents.

Referring next to expressions, “M”->SQL can translate most “M” expressions including operators (e.g., *, /, +, −), queries (e.g., “from person in People where person.Age>=21”), constants and initializers (e.g, “astring”, {1, 2, 3}), and other expressions such as member access and function calls (e.g., person.Age). These expressions can be used in several different contexts, including computed values, constraints, default values, and initializers. And although “M” supports a wide range of expressions over a wide range of types, some “M”->SQL embodiments may only support expressions that return scalars, entities and collections of scalars or entities (i.e., the same set of types that are supported by extent->table translation).

In an embodiment, it should be noted that expressions are composable—the result of one expression can be used in another expression. Hereinafter, because only a few of a plurality of compositions are discussed, the following statements will be used to mean any “M” expression that can fit into A and B:

### A+B->A+B

### A.Count->LEN(A)

Accordingly, wherever MyString.Count+10 is provided in “M”, the translated SQL will look like (LEN(MyString))+10. Query expressions may be similarly composed. For instance,

### A|B->A UNION B

may take the SQL query expression for A and the SQL query expression for B and place them into those slots. Moreover, “Foos|Bars” may be turned into “(SELECT*FROM Foos) UNION (SELECT*FROM Bars)”.

With respect to constants, it should be noted that the majority of constants may be translated verbatim. An exemplary non-exhaustive list of “M” literals and their SQL equivalents is provided in Table T-13.

TABLE T-13

| M Type | M Example | SQL Example |
|---|---|---|
| Decimal | 1234.567 | 1234.567 |
| Integer | 1234 | 1234 |
| Scientific | 1234.567e+89 | 1.234567E+92 |
| Date | 2008-05-04 | ‘2008-05-04’ |
| DateTime | 2008-05-04T18:27:36 | ‘2008-05-04T18:27:36’ |
| Time | 18:27:36 | Not yet implemented |
| Character | ‘c’ | N‘c’ |
| Text | “little bunny ‘fufu’” | N‘little bunny ‘‘fufu’’’ |
| Logical | true | 1 |
| | false | 0 |
| Binary | 0x01200340 | 0x01200340 |
| Null | Null | Null |
| Guid | #[12345678-1234-1234-1234- | ‘12345678-1234-1234-1234- |
| | 123456789012] | 123456789012’ |

With respect to numeric expressions, it should be noted that numeric values have a relatively small number of operators that can act upon them. In one aspect, these operators may thus generally be translated verbatim to SQL. Exemplary translations for numeric operators are provided in Table T-14.

TABLE T-14

| Operator | M Example | SQL Example |
|---|---|---|
| *, /, +, −, % | A op B | A op B |
| +, − (unary) | op A | op A |
| <, >, >=, | A op B | A op B |
| <= | | |
| == | A == B | A = B |
| != | A != B | A <> B |

Exceptions to the above, however, may exist including: Integer8/16/32/64 and Unsigned8/16/32 divide. These operators may translate to “convert(decimal(x,6), A)/convert(decimal(x,6), B)” (where x is replaced by the smallest possible decimal value that can represent the entire range of values for the concrete integer type). Translations for Single and Double modulo operators may also be contemplated, as well as translations for string expression operators. Exemplary translations for string expression operators are provided in Table T-15.

TABLE T-15

| Operator | M Example | SQL Example |
|---|---|---|
| Count | A# | LEN(A) |
| | A.Count | |
| Concatenation | A + B | A + B |
| Comparison | A < B | A < B |
| | A <= B | A <= B |
| | A > B | A > B |
| | A >= B | A >= B |
| | A == B | A = B |
| | A != B | A <> B |
| Like | A.Like(B) | Not currently implemented |
| PatternIndex | A.PatternIndex(B) | Not currently implemented |

Date expression operators including operators for expressions defined on Date, DateTime and Time, may also be supported. Exemplary translations for such date expression operators are provided in Table T-16.

TABLE T-16

| Operator | M Example | SQL Example |
|---|---|---|
| Addition | A + B | A + convert(datetime, B) |
| Equality | A == B | A = B |
| Inequality | A != B | A <> B |
| Relational | A <= B | A <= B |
| | A >= B | A >= B |
| | A < B | A < B |
| | A > B | A > B |

Binary expression operators may also be supported. Exemplary translations for such binary expression operators are provided in Table T-17.

TABLE T-17

| Operator | M Example | SQL Example |
|---|---|---|
| ~ | ~A | Not currently |
| | | implemented |
| &, \hat{ }, \| | A op B | Not currently |
| | | implemented |
| == | A == B | A = B |
| != | A != B | A <> B |
| <<, >> | A op B | Not currently |
| | | implemented |

Byte expression operators may also be supported. Exemplary translations for such byte expression operators are provided in Table T-18.

TABLE T-18

| Operator | M Example | SQL Example |
|---|---|---|
| ~ | ~A | ~A |
| &, \hat{ }, \| | A op B | A op B |
| == | A == B | A = B |
| != | A != B | A <> B |
| <<, >> | A op B | Not currently |
| | | implemented |

GUID expression operators may also be supported. Exemplary translations for such GUID expression operators are provided in Table T-19.

TABLE T-19

| Operator | M Example | SQL Example |
|---|---|---|
| ~ | ~A | Not currently |
| | | implemented |
| &, \hat{ }, \| | A op B | Not currently |
| | | implemented |
| == | A == B | A = B |
| != | A != B | A <> B |
| <<, >> | A op B | Not currently |
| | | implemented |

Logical expression operators may also be supported. Exemplary translations for such logical expression operators are provided in Table T-20.

TABLE T-20

| Operator | M Example | SQL Example |
|---|---|---|
| Not | ! A | not A |
| And | A && B | A and B |
| Or | A \|\| B | A or B |
| Equal | A == B | A = B |
| Not Equal | A != B | A <> B |

Conditional operators may also be supported. Exemplary translations for such conditional operators are provided in Table T-21.

TABLE T-21

| Operator | M Example | SQL Example |
|---|---|---|
| Conditional | A ? B : C | Not currently implemented |
| Coalesce | A ?? B | Case |
| | | when A is null then B |
| | | else A |
| | | end |

Referring next to nullable expressions, in an embodiment, the == and != operators in “M” have the semantic that null ==null and null !=1. In SQL, both of these return “unknown,” a third truth value that may not be supported in “M”. In order to get the “M” semantics, when one side of an operator is a nullable type (for example, F(a:Integer32?, b:Integer32?) {a==b}), a special case logic may be generated that checks for null values to ensure that null == null and null !=1 turn out true. In an embodiment, this applies to all supported scalar types. In other embodiments, it should be noted that translations for nullable entity comparison may also be contemplated. It should be further noted that nullable comparison operators (<, >, <=, >=) operating on nullable integers may actually return Logical?: 1<=2 is true, 2<=1 is false, null <=null is null, and 1<=null is null, which may apply to all supported numeric types. Exemplary translations for such nullable expression operators are provided in Table T-22.

TABLE T-22

| Operator | M Example | SQL Example |
|---|---|---|
| Nullable == | A == B | (A is null and B is null) or |
| | | (A is not null and B is not null and A = B) |
| Nullable != | A != B | (A is null and B is not null) or |
| | | (A is not null and B is null) or |
| | | (A is not null and B is not null and A <> B) |
| Nullable | A < B | Case |
| Comparison | A > B | when A is null or B is null then null |
| | A <= B | when A <comparison op> B then 1 |
| | A >= B | else 0 |
| | | end |

Explicit conversion operators may also be supported. An exemplary translation for such a conversion operator is provided in Table T-23.

TABLE T-23

| Operator | M Example | SQL Example |
|---|---|---|
| Cast | A : T | convert (SQL type of T, A) |

Referring next to implicit conversion, it should be noted that although “M” allows logical values to intermingle with other scalars, SQL does not support such intermingling. Therefore, logical expressions like == may not be stored directly in an SQL table, or returned as a scalar or as the result of a query. In an embodiment, “bit” is used for that instead, which may require translating the result of == into a “1” or “0.” Likewise, logical values stored in tables as “bit”s may not be used directly in logical expressions like NOT, AND and OR (or where clauses of queries), so expr==1 may need to be used. So where necessary, expression conversion may automatically convert as described in Table T-24 below.

TABLE T-24

| Operation | M Example | SQL Example |
|---|---|---|
| Scalar -> Logical | module M { | create table [M].[People] |
| | type Person { Name : Text; | ( |
| | IsOld : Logical; } | [IsOld] bit not null, |
| | People : Person*; | [Name] nvarchar(max) not null |
| | OldPeople { People where | ); |
| | value.IsOld } | create view [M].[OldPeople] |
| | } | as |
| | | select [t0].[Name], [t0].[IsOld] |
| | | from ( select [IsOld] as |
| | | [IsOld], [Name] as [Name] |
| | | from [M].[People]) as [t0] |
| | | where (select [t0].[IsOld] as |
| | | [Item]) = 1; |
| Scalar -> Logical | module M { | create function [M].[NegateIt] |
| | NegateIt(x : Logical) : | ( |
| | Logical { ! x } | @x as bit |
| | } | ) |
| | | returns bit as |
| | | begin |
| | | return case |
| | | when not @x = 1 then 1 |
| | | else 0 |
| | | end |
| | | end |

Referring next to global references, it should again be noted that “M”->SQL may translate computed values and extents into functions, views, and tables. In an embodiment, expressions are capable of referencing them as well. Within such embodiment, when an extent is used as an expression, the expression may always mean “get all the data out of this expression.” Exemplary translations for such global references are provided in Table T-25.

TABLE T-25

| Type | M Example | SQL Example |
|---|---|---|
| Table | module M { | create table [M].[Foos] |
| | type Foo { | ( |
| | i : Integer32; | [i] int not null, |
| | j : Integer32; | [j] int not null |
| | } | ); |
| | Foos : Foo*; | create view |
| | FooExpression( ) : Foo* { Foos } | [M].[FooExpression] |
| | } | ( |
| | | [i], |
| | | [j] |
| | | ) |
| | | as |
| | | select [i] as [i], [j] as |
| | | [j] |
| | | from [M].[Foos]; |
| View | module M { | create table [M].[Foos] |
| | type Foo { | ( |
| | i : Integer32; | [i] int not null, |
| | j : Integer32; | [j] int not null |
| | } | ); |
| | Foos : Foo*; | create view [M].[FooView] |
| | FooView( ) : Foo* { Foos } | ( |
| | FooExpression( ) : Foo* { FooView } | [i], |
| | } | [j] |
| | | ) |
| | | as |
| | | select [i] as [i], [j] as |
| | | [j] |
| | | from [M].[Foos]; |
| | | create view |
| | | [M].[FooExpression] |
| | | ( |
| | | [i], |
| | | [j] |
| | | ) |
| | | as |
| | | select [i] as [i], [j] as |
| | | [j] |
| | | from [M].[FooView]; |
| Table Valued | module M { | create table [M].[Foos] |
| Function | type Foo { | ( |
| | i : Integer32; | [i] int not null, |
| | j : Integer32; | [j] int not null |
| | } | ); |
| | Foos : Foo*; | go |
| | FooFunction(x : Integer32) : Foo* { | create function |
| | Foos where value.i > 10 } | [M].[FooFunction] |
| | FooExpression( ) : Foo* { | ( |
| | FooFunction(10) } | @x as int |
| | } | ) |
| | | returns table |
| | | as return ( |
| | | select [$value].[i] as |
| | | [i], [$value].[j] as [j] |
| | | from [M].[Foos] as |
| | | [$value] |
| | | where [$value].[i] > 10 |
| | | ) |
| | | go |
| | | create view |
| | | [M].[FooExpression] |
| | | ( |
| | | [i], |
| | | [j] |
| | | ) |
| | | as |
| | | select [i] as [i], [j] as |
| | | [j] |
| | | from [M].[FooFunction]( |
| | | 10); |
| Scalar | module M { | create function [M].[Square] |
| Function | Square(x : Integer32) : Integer32 { | ( |
| | x * x } | @x as int |
| | Cube(x : Integer32) : Integer32 { | ) |
| | Square(x) * x } | returns int as |
| | } | begin |
| | | return @x * @x |
| | | end |
| | | create function [M].[Cube] |
| | | ( |
| | | @x as int |
| | | ) |
| | | returns int as |
| | | begin |
| | | return [M].[Square](@x) |
| | | * @x |
| | | end |

In an embodiment, translations for operations on collection expressions (i.e., expressions which work on collections) may also be supported. Exemplary translations for such operations are provided in Table T-26.

TABLE T-26

| Operator | M Example | SQL Example |
|---|---|---|
| Subset | A <= B | not exists (A except B) |
| Superset | A >= B | not exists (B except A) |
| Strict Subset | A < B | not exists (A except B) and exists |
| | | (B except A) |
| Strict Superset | A > B | not exists (B except A) and exists |
| | | (A except B) |
| Equal | A == B | not exists (A except B) and not exists |
| | | (B except A) |
| Not equal | A != B | exists (A except B) or exists (B except A) |
| In | A in B | A in B |
| Union | A \| B | A union B |
| Intersection | A & B | A intersect B |
| Where | A where B | Equivalent to “from value in A where B |
| | | select value” |
| Select | A select B | Equivalent to “from value in A select B” |
| Choose | A.Choose | Not currently implemented |
| Count | A# | Not currently implemented |
| | A.Count | |
| Distinct | A.Distinct | Not currently implemented |

With respect to entity types from different tables, it should be noted that translations for Set Comparison (subset, equal, etc.). In, and Intersection may also be contemplated when used over entity types that come from different tables. Furthermore, with respect to entity types with different fields, translations for Union may be contemplated when used over entity types with different sets of fields (e.g., by using different tables).

In an embodiment, translations for operations specific to entity collections may also be supported. Exemplary translations for such operations are provided in Table T-27.

TABLE T-27

| Operation | M Example | SQL Example |
|---|---|---|
| Projector | A.field | Equivalent to “from value in A select |
| | | value.field” |
| Selector | A.field(B) | Equivalent to “from value in A where |
| | | value.field = B select value” |
| Table Selector | A(B) | Not currently implemented |

In an embodiment, translations for operations specific to logical collections may also be contemplated. Exemplary operations which may be specific to logical collections are provided in Table T-28.

TABLE T-28

| Operation | M Example | SQL Example |
|---|---|---|
| All | A.All | Not currently implemented |
| Exists | A.Exists | Not currently implemented |

In an embodiment, translations for operations specific to numeric collections may also be contemplated. Exemplary operations which may be specific to numeric collections are provided in Table T-29.

TABLE T-29

| Operation | M Example | SQL Example |
|---|---|---|
| Average | A.Average | Not currently implemented |
| Maximum | A.Maximum | Not currently implemented |
| Minimum | A.Minimum | Not currently implemented |
| Sum | A.Sum | Not currently implemented |

It should be noted that query modifiers may provide a more complex and feature-rich query syntax for collections, such as the “from . . . ” statement which has a number of clauses, each of which translates roughly separately from the others. Exemplary translations for such query modifiers are provided in Table T-30.

TABLE T-30

| Modifier | M Example | SQL Example |
|---|---|---|
| From | from ident in A | select . . . from A as ident |
| | from identA in A from | select . . . from A as identA |
| | identB in B | cross join B as identB |
| Join | join ident in A on B equals C | Not currently implemented |
| join . . . into | Join ident in A on B equals C | Not currently implemented |
| | into ident2 | |
| Where | where A | select . . . where A |
| | where A where B | select . . . where A and B |
| Let | let A = B | Not currently implemented |

In Table T-30 above, it should be noted that the “from” expressions bring “ident” into scope as a variable. For scalar collections, future references to “ident” may resolve as [ident].[Item]. For entity collections, references to “ident” may resolve as (select [ident].<column1>, [ident].<column2, . . . ). It should be further noted that Join may support comparison of scalars and entities with identity, but not necessarily collections or other entities.

Next, a discussion of “result gatherers” is provided. Result gatherers are the terminus of a query, which may include “select”, “group”, or “accumulate.” “group” and “accumulate” are presently unsupported. An exemplary translation for a select operation is provided in Table T-31.

TABLE T-31

| Operation | M Example | SQL Example |
|---|---|---|
| Select | select A | select t0.a, t0.b, . . . |
| | | from (<from clauses) |
| | | cross apply A as t0 |
| | | <where clauses> |

Here, it should be appreciated that the CROSS APPLY may be optimized out in simple cases (such as anonymous entities). Therefore, the following query:

```
module M {
    type Foo { Id : Integer32; i : Integer32; } where
identity(Id);
    Foos : Foo*;
    type Bar { Id : Integer32; j : Integer32; } where
identity(Id);
    Bars : Bar*;
    F( ) { from foo in Foos from bar in Bars where foo.i ==
bar.j select { i = foo.i, j = bar.j } }
}
```

Translates to this:

```
  select [t0].[i] as [i], [t0].[Id] as [Id]
  from [M].[Foos] as [foo] -- from foo in Foos
    cross join [M].[Bars] as [bar] -- from bar in Bars
      cross apply (select [foo].[i] as [i], [bar].[j] as [j])
as [t0] -- select { i = foo.i, j = bar.j }
  where [foo].[i] = [bar].[j]; -- where foo.i == bar.j
```

Which is then optimized to this:

```
select [foo].[i] as [i], [bar].[j] as [j] -- select { i =
foo.i, j = bar.j }
  from [M].[Foos] as [foo] -- from foo in Foos
    cross join [M].[Bars] as [bar] -- from bar in Bars
  where [foo].[i] = [bar].[j] -- where foo.i == bar.j
```

In an embodiment, translations for query continuations may also be contemplated. Query continuations allow queries to be chained together, storing the result of a first query in a variable that can then be used in a second query. An exemplary query continuation operation is provided in Table T-32.

TABLE T-32

| Operation | M Example | SQL Example |
|---|---|---|
| Into | Query1 into var Query2 | Not currently implemented |

Translations for operations on entity expressions may also be supported. Here, it should be noted that entities in “M” are a single collection of field/value pairs (i.e., a row in a table). Exemplary translations for such operations are provided in Table T-33.

TABLE T-33

| Operation | M Example | SQL Example |
|---|---|---|
| Equality | A == B | <ID field of A> = <ID field of B> |
| Inequality | A != B | <ID field of A> <> <ID field of B> |
| Field names | A.FieldNames | Not currently implemented |
| Indexer | A(B) | Not currently implemented |
| Cast | A : B | Not currently implemented |

In an embodiment, member access in “M” operates over a single entity. Within such embodiment, member access may have several permutations depending on the type of the field being accessed. Exemplary translations for various member access operations are provided in Table T-34.

TABLE T-34

| | M | |
|---|---|---|
| Operation | Example | SQL Example |
| Member Access: Scalar | A.field | select field as [Item] from A |
| Member Access: Scalar | A.field | Not currently implemented |
| Collection | | |
| MemberAccess: Entity | A.field | select <entity columns> |
| | | from <entity storage table> as |
| | | [t0] inner join A as [t1] on |
| | | [t1].field = [t0].[Id]; |
| | | (For entities with multiple identity |
| | | fields, the “on” statement |
| | | compares multiple columns.) |
| Member Access: Entity | A.field | Not currently implemented |
| Collection | | |

In an embodiment, entity and entity collection member access retrieves the entities, including all of their fields, from the table where the entities are stored. A full example is provided in Table T-35.

TABLE T-35

| | | |
|---|---|---|
| Member | module M { | create table [M].[Bars] |
| Access: | type Foo { | ( |
| Entity | Id : Integer32; | [Id] int not null, |
| | bar : Bar; | [j] int not null, |
| | i : Integer32; | constraint [PK_Bars] primary key clustered |
| | } where identity(Id); | ([Id]) |
| | type Bar { | ); |
| | Id : Integer32; | create table [M].[SingleFoo] |
| | j : Integer32; | ( |
| | } where identity(Id); | [Id] int not null, |
| | Bars : Bar*; | [bar] int not null, |
| | SingleFoo : Foo | [i] int not null, |
| | where value.bar in | constraint [PK_SingleFoo] primary key |
| | Bars; | clustered ([Id]), |
| | F( ) { SingleFoo.bar } | constraint [FK_SingleFoo_bar_M_Bars] foreign |
| | } | key ([bar]) references [M].[Bars] ([Id]) |
| | | ); |
| | | create view [M].[F] |
| | | ( |
| | | [Id], |
| | | [j] |
| | | ) |
| | | as |
| | | select [t0].[Id] as [Id], [t0].[j] as [j] |
| | | from [M].[Bars] as [t0] |
| | | inner join [M].[SingleFoo] as [t1] on |
| | | [t1].[bar] = [t0].[Id]; |

Here, it should be noted that other embodiments may also contemplate member access to Computed Columns.

In an embodiment, “M” supports the creation of anonymous collections in an expression (such as {1, 2, 4, 8, 16}). In one aspect, such creation is supported using queries and UNION ALL so that the collections can be returned from views and used anywhere expressions can be used. Exemplary translations of anonymous collections are provided in Table T-36.

TABLE T-36

| Type | M Example | SQL Example |
|---|---|---|
| Scalar collection | module M { | create table [M].[Thirty] |
| | Thirty : Integer32 = 30; | ( |
| | V { { 1, 10, 3, Thirty, 2, 20, | [Item] int not null |
| | 20 } } | ); |
| | } | create view [M].[V] |
| | | as |
| | | select 1 as [Item] |
| | | union all |
| | | select 10 as [Item] |
| | | union all |
| | | select 3 as [Item] |
| | | union all |
| | | select [Item] as [Item] |
| | | from [M].[Thirty] |
| | | union all |
| | | select 2 as [Item] |
| | | union all |
| | | select 20 as [Item] |
| | | union all |
| | | select 20 as [Item]; |
| Entity collection | module M | create table [M].[SingleA] |
| | { | ( |
| | SingleA : { | [i] int not null, |
| | i : Integer32; | [j] nvarchar(max) not null |
| | j : Text; | ); |
| | } = { i = 100, j = “hundred” }; | insert into [M].[SingleA] |
| | V { | ([i], [j]) |
| | { | values (100, N‘hundred’); |
| | { i = 20, j = “twenty” }, | create view [M].[V] |
| | SingleA, | as |
| | { i = 10, j = “ten” }, | select 20 as [i], |
| | { i = 20, j = “twenty” } | N‘twenty’ as [j] |
| | } | union all |
| | } | select [i] as [i], [j] as |
| | } | [j] |
| | | from [M].[SingleA] |
| | | union all |
| | | select 10 as [i], N‘ten’ |
| | | as [j] |
| | | union all |
| | | select 20 as [i], |
| | | N‘twenty’ as [j]; |
| Empty collection | module M | create view [M].[V] |
| | { | as |
| | V { { } } | select 1 |
| | } | where 1 = 0; |

Here, it should be further noted that embodiments may be contemplated in which “M”->SQL supports anonymous collections with entities of different types (different sets of columns) or collections of collections.

In an embodiment, “M” also supports the creation of simple entities in an expression (i.e. an anonymous group of name/value pairs). Such creation may be achieved by using the right side of a “from . . . select” query. In one aspect, “M”->SQL supports these by creating a SELECT statement, naming each field with the given name. Within such embodiment, if an entity reference is put as a column, that id of that entity will be assigned to the field. Exemplary translations of anonymous entities are provided in Table T-37.

TABLE T-37

| Type | M Example | SQL Example |
|---|---|---|
| Entity with | module M { | create table [M].[Foos] |
| scalars | type Foo { i : Integer32; j : | ( |
| | Integer32; } | [i] int not null, |
| | Foos : Foo*; | [j] int not null |
| | SelectFoos { from foo in Foos | ); |
| | select { x = foo.i+1, y = foo.j+1, | create view [M].[SelectFoos] |
| | combo = foo.i+foo.j } } | as |
| | } | select [t0].[i] + 1 as [x], |
| | | [t0].[j] + 1 as [y], [t0].[i] + |
| | | [t0].[j] as [combo] |
| | | from ( select [i] as [i], |
| | | [j] as [j] |
| | | from [M].[Foos]) as [t0]; |
| Entity | module M { | create table [M].[Bars] |
| containing | type Bar { id : Integer32; } | ( |
| entity ref | where identity(id); | [id] int not null, |
| | type Foo { i : Integer32; bar | constraint [PK_Bars] primary |
| | : Bar where value in Bars; } | key clustered ([id]) |
| | Bars : Bar*; | ); |
| | Foos : Foo*; | create table [M].[Foos] |
| | SelectFoos { from foo in Foos | ( |
| | select { thebar = foo.bar } } | [bar] int not null, |
| | } | [i] int not null, |
| | | constraint [FK_Foos_bar_Bars] |
| | | foreign key ([bar]) references |
| | | [M].[Bars] ([id]) |
| | | ); |
| | | create view [M].[SelectFoos] |
| | | as |
| | | select (select [id] |
| | | from ( select [id] as [id] |
| | | from [M].[Bars]) as [t1] |
| | | where [_Id] = (select |
| | | [t0].[bar] as [Item])) as |
| | | [thebar] |
| | | from ( select [bar] as |
| | | [bar], [i] as [i] |
| | | from [M].[Foos]) as [t0]; |

In an embodiment, “M”->SQL may also support global built-in functions. An exemplary translation of such a global built-in function is provided in Table T-38.

TABLE T-38

| M Example | SQL Example |
|---|---|
| NewGuid( ) | NEWID( ) |

It should also be appreciated that there are a plurality of “M” constructs that have no translation in “M”->SQL, including “type”, “import” and “export” which have no corresponding meaning in SQL. In an embodiment, these constructs are merely used to create the tables, views or functions, and are then discarded.

### Exemplary Networked and Distributed Environments

One of ordinary skill in the art can appreciate that the various embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may cooperate to perform one or more aspects of any of the various embodiments of the subject disclosure.

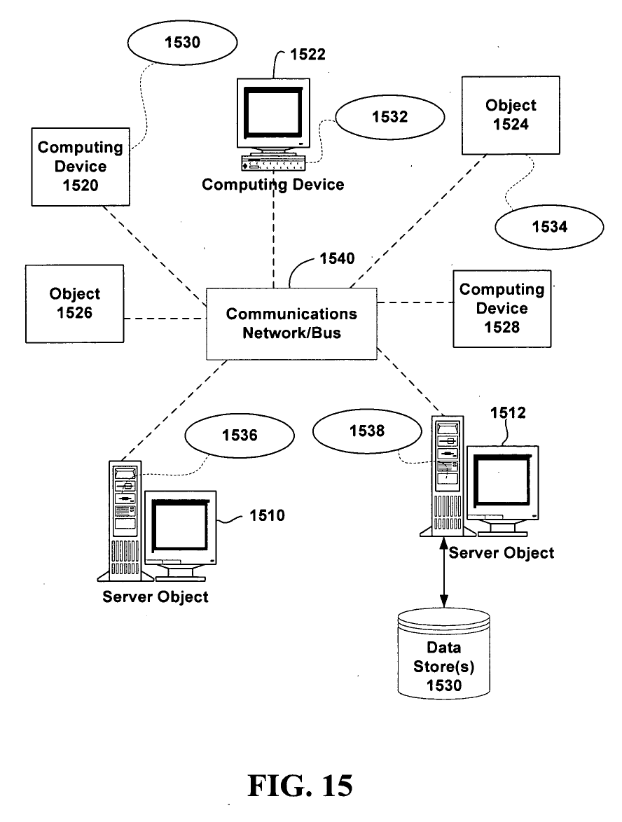

FIG. 15 provides a schematic diagram of an exemplary networked or distributed computing environment. The distributed computing environment comprises computing objects 1510, 1512, etc. and computing objects or devices 1520, 1522, 1524, 1526, 1528, etc., which may include programs, methods, data stores, programmable logic, etc., as represented by applications 1530, 1532, 1534, 1536, 1538. It can be appreciated that objects 1510, 1512, etc. and computing objects or devices 1520, 1522, 1524, 1526, 1528, etc. may comprise different devices, such as PDAs, audio/video devices, mobile phones, MP3 players, personal computers, laptops, etc.

Each object 1510, 1512, etc. and computing objects or devices 1520, 1522, 1524, 1526, 1528, etc. can communicate with one or more other objects 1510, 1512, etc. and computing objects or devices 1520, 1522, 1524, 1526, 1528, etc. by way of the communications network 1540, either directly or indirectly. Even though illustrated as a single element in FIG. 15, network 1540 may comprise other computing objects and computing devices that provide services to the system of FIG. 15, and/or may represent multiple interconnected networks, which are not shown. Each object 1510, 1512, etc. or 1520, 1522, 1524, 1526, 1528, etc. can also contain an application, such as applications 1530, 1532, 1534, 1536, 1538, that might make use of an API, or other object, software, firmware and/or hardware, suitable for communication with, processing for, or implementation of the column based encoding and query processing provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the column based encoding and query processing as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 15, as a non-limiting example, computers 1520, 1522, 1524, 1526, 1528, etc. can be thought of as clients and computers 1510, 1512, etc. can be thought of as servers where servers 1510, 1512, etc. provide data services, such as receiving data from client computers 1520, 1522, 1524, 1526, 1528, etc., storing of data, processing of data, transmitting data to client computers 1520, 1522, 1524, 1526, 1528, etc., although any computer can be considered a client, a server, or both, depending on the circumstances. Any of these computing devices may be processing data, encoding data, querying data or requesting services or tasks that may implicate the column based encoding and query processing as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the column based encoding and query processing can be provided standalone, or distributed across multiple computing devices or objects.

In a network environment in which the communications network/bus 1540 is the Internet, for example, the servers 1510, 1512, etc. can be Web servers with which the clients 1520, 1522, 1524, 1526, 1528, etc. communicate via any of a number of known protocols, such as the hypertext transfer protocol (HTTP). Servers 1510, 1512, etc. may also serve as clients 1520, 1522, 1524, 1526, 1528, etc., as may be characteristic of a distributed computing environment.

### Exemplary Computing Device

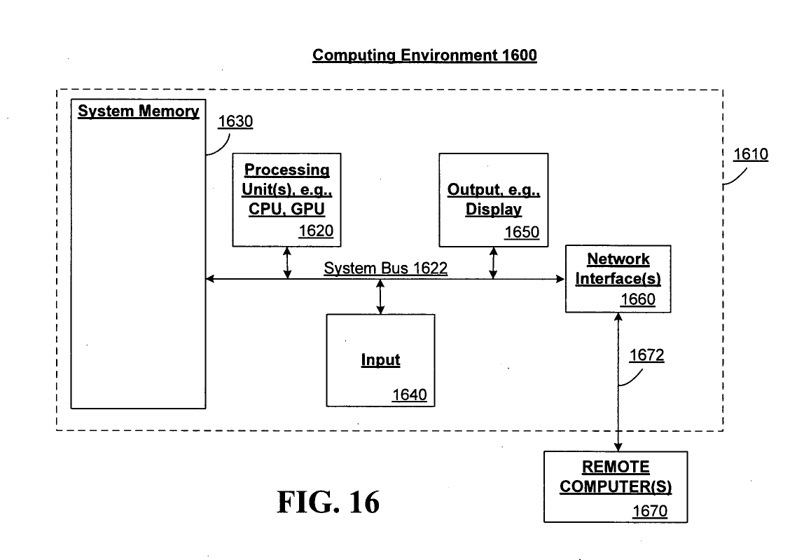

As mentioned, advantageously, the techniques described herein can be applied to any device where it is desirable to query large amounts of data quickly. It should be understood, therefore, that handheld, portable and other computing devices and computing objects of all kinds are contemplated for use in connection with the various embodiments, i.e., anywhere that a device may wish to scan or process large amounts of data for fast and efficient results. Accordingly, the below general purpose remote computer described below in FIG. 16 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 16 thus illustrates an example of a suitable computing system environment 1600 in which one or aspects of the embodiments described herein can be implemented, although as made clear above, the computing system environment 1600 is only one example of a suitable computing environment and is not intended to suggest any limitation as to scope of use or functionality. Neither should the computing environment 1600 be interpreted as having any dependency or requirement relating to any one or combination of components illustrated in the exemplary operating environment 1600.

With reference to FIG. 16, an exemplary remote device for implementing one or more embodiments includes a general purpose computing device in the form of a computer 1610. Components of computer 1610 may include, but are not limited to, a processing unit 1620, a system memory 1630, and a system bus 1622 that couples various system components including the system memory to the processing unit 1620.

Computer 1610 typically includes a variety of computer readable media and can be any available media that can be accessed by computer 1610. The system memory 1630 may include computer storage media in the form of volatile and/or nonvolatile memory such as read only memory (ROM) and/or random access memory (RAM). By way of example, and not limitation, memory 1630 may also include an operating system, application programs, other program modules, and program data.

A user can enter commands and information into the computer 1610 through input devices 1640. A monitor or other type of display device is also connected to the system bus 1622 via an interface, such as output interface 1650. In addition to a monitor, computers can also include other peripheral output devices such as speakers and a printer, which may be connected through output interface 1650.

The computer 1610 may operate in a networked or distributed environment using logical connections to one or more other remote computers, such as remote computer 1670. The remote computer 1670 may be a personal computer, a server, a router, a network PC, a peer device or other common network node, or any other remote media consumption or transmission device, and may include any or all of the elements described above relative to the computer 1610. The logical connections depicted in FIG. 16 include a network 1672, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to compress large scale data or process queries over large scale data.

Also, there are multiple ways to implement the same or similar functionality, e.g., an appropriate API, tool kit, driver code, operating system, control, standalone or downloadable software object, etc. which enables applications and services to use the efficient encoding and querying techniques. Thus, embodiments herein are contemplated from the standpoint of an API (or other software object), as well as from a software or hardware object that provides column based encoding and/or query processing. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A method for mapping between constructs in a domain modeling language and a relational storage language, including:
receiving a source code, the source code authored in a source language, the source language being one of either the domain modeling language or the relational storage language;
identifying a set of constructs in the source code;
mapping the set of constructs in the source code to a set of constructs in a target language, the target language being one of either the domain modeling language or the relational storage language, the target language being different than the source language; and
compiling the source code into a target code, the target code authored in the target language, at least one of the source code or target code including a declarative constraint-based execution model.

2. The method of claim 1, the mapping step further comprising mapping a source initialization value in the source code to a target initialization value in the target code.

3. The method of claim 2, the source code including a calling of the source initialization value with a source label, the mapping step further comprising mapping the calling of the source initialization value with a calling of the target initialization value with a target label.

4. The method of claim 1, the mapping step comprising mapping at least one storage specifier to at least one table, the at least one storage specifier associated with the domain modeling language and the at least one table associated with the relational storage language.

5. The method of claim 4, the at least one storage specifier including at least one field, the mapping step comprising mapping the at least one storage specifier as the at least one table including at least one column.

6. The method of claim 5, a first storage specifier including a first field and a second storage specifier including a plurality of fields, the mapping step comprising mapping the first field referencing the second storage specifier as a first column in a first table referencing a second table.

7. The method of claim 6, the mapping step comprising mapping the first field referencing one of the plurality of fields as the first column referencing the second table and including a unique constraint.

8. The method of claim 5, the mapping step comprising mapping a first field in a first storage specifier referencing a domain modeling language initialization value in a second field in a second storage specifier as a first column in a first table referencing a relational language initialization value in a second column in a second table.

9. The method of claim 5, a first storage specifier including a first field and a second field, the mapping step comprising mapping the first field referencing a first external field and the second field referencing a second external field as a first column in a first table referencing a first external column and a second column in the first table referencing a second external column, each of the first external column and the second external column being external to the first table.

10. The method of claim 1, the mapping step comprising mapping a source constraint in the source code as a target constraint in the target code.

11. The method of claim 2, the mapping step comprising mapping retrieving a value in the at least one storage specifier as selecting a cell in the at least one table.

12. The method of claim 2, the mapping step comprising mapping retrieving a plurality of values in the at least one storage specifier as performing a union operation on a selection of a plurality of cells in the at least one table.

13. A system for mapping between constructs in a domain modeling language and a relational storage language, including:
a receiving component, the receiving component configured to receive a source code, the source code authored in a source language, the source language being one of either the domain modeling language or the relational storage language;
a first construct library, the first construct library configured to store a plurality of constructs that support the domain modeling language;
a second construct library, the second construct library configured to store a plurality of constructs that support the relational storage language;
a processor component, the processor component configured to execute computer-readable instructions for mapping a set of constructs in the source code to a set of constructs in a target language, the target language being one of either the domain modeling language or the relational storage language, the target language being different than the source language a compiling component, the compiling component configured to generate a target code, the target code authored in the target language and analogous to the source code, at least one of the source code or target code including a declarative order-independent execution model.

14. The system of claim 13, the processor further configured to execute instructions for mapping a source initialization value in the source code to a target initialization value in the target code.

15. The system of claim 14, the processor further configured to execute instructions for mapping a calling of the source initialization value with a source label as a calling of the target initialization value with a target label, the source label identifying a source location for the source initialization value, the target label identifying a target location for the target initialization value.

16. The system of claim 13, the processor further configured to execute instructions for mapping at least one storage specifier to at least one table, the at least one storage specifier associated with the domain modeling language and the at least one table associated with the relational storage language.

17. The system of claim 16, the at least one storage specifier including at least one field, the processor further configured to execute instructions for mapping the at least one storage specifier as the at least one table including at least one column.

18. The system of claim 17, a first storage specifier including a first field and a second storage specifier including a plurality of fields, the processor further configured to execute instructions for mapping the first field referencing the second storage specifier as a first column in a first table referencing a second table.

19. The system of claim 18, the processor further configured to execute instructions for mapping the first field referencing one of the plurality of fields as the first column referencing the second table and including a unique constraint.

20. The system of claim 17, the processor further configured to execute instructions for mapping a first field in a first storage specifier referencing a domain modeling language initialization value in a second field in a second storage specifier as a first column in a first table referencing a relational language initialization value in a second column in a second table.

21. The system of claim 17, a first storage specifier including a first field and a second field, the processor further configured to execute instructions for mapping the first field referencing a first external field and the second field referencing a second external field as a first column in a first table referencing a first external column and a second column in the first table referencing a second external column, each of the first external column and the second external column being external to the first table.

22. The system of claim 16, the processor further configured to execute instructions for mapping retrieving a value in the at least one storage specifier as selecting a cell in the at least one table.

23. A system for mapping between an M language programming code and an SQL programming code, including:
means for receiving a source code, the source code authored in a source language, the source language being one of either M or SQL;
means for identifying a set of constructs in the source code;
means for mapping the set of constructs in the source code to a set of constructs in a target language, the target language being one of either M or SQL, the target language being different than the source language; and
means for compiling the source code into a target code, the target code authored in the target language, at least one of the source code or target code including a declarative constraint-based and order-independent execution model.
